(19) United States
(12) Patent Application Publication
(10) Pub. No.: US 2026/0362481 A1
(43) Pub. Date: Nov. 12, 2026

(54) DEVICE AND METHOD FOR PERFORMING FULL-DUPLEX-BASED COMMUNICATION IN UNLICENSED BAND IN WIRELESS COMMUNICATION SYSTEM

(71) Applicant: LG ELECTRONICS INC., Seoul (KR)

(72) Inventors: Seonwook KIM, Seoul (KR); Kijun KIM, Seoul (KR); Joonkui AHN, Seoul (KR); Hyunsoo KO, Seoul (KR)

(73) Assignee: LG ELECTRONICS INC., Seoul (KR)

(21) Appl. No.: 19/109,958

(22) PCT Filed: Sep. 22, 2023
(86) PCT No.: PCT/KR2023/014534

§ 371 Date: Mar. 7, 2025

(30) Foreign Application Priority Data
Sep. 23, 2022 (KR) 10-2022-0121180

(51) Int. Cl. H04W 74/0808; H04L 5/14

(52) U.S. Cl. CPC H04W 74/0808; H04L 5/14

(57) ABSTRACT

The present disclosure relates to performing full-duplex-based communication in an unlicensed band in a wireless communication system. A method for operating a base station may include transmitting system information including information related to a communication band, transmitting configuration information related to distinguishing an uplink resource and a downlink resource in the communication band, based on at least one of the system information or the configuration information, performing a first channel access procedure (CAP) for a first channel and a second channel included in the communication band, based on the first CAP being successful in the first channel, transmitting a signal in the first channel, and performing a second CAP for the second channel during transmission of the signal in the first channel.

### CROSS-REFERENCE TO RELATED APPLICATIONS

This application is the National Stage filing under 35 U.S.C. 371 of International Application No. PCT/KR2023/014534, filed on Sep. 22, 2023, which claims the benefit of earlier filing date and right of priority to Korean Application No. 10-2022-0121180, filed on Sep. 23, 2022, the contents of which are all hereby incorporated by reference herein in their entireties.

### TECHNICAL FIELD

The present disclosure relates to a wireless communication system, and more particularly, to an apparatus and method for performing full-duplex-based communication in an unlicensed band in a wireless communication system.

### BACKGROUND

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

In particular, as a large number of communication devices require a large communication capacity, the enhanced mobile broadband (eMBB) communication technology, as compared to the conventional radio access technology (RAT), is being proposed. In addition, not only massive machine type communications (massive MTC), which provide a variety of services anytime and anywhere by connecting multiple devices and objects, but also a communication system considering a service/user equipment (UE) sensitive to reliability and latency is being proposed. Various technical configurations for this are being proposed.

### SUMMARY

The present disclosure may provide an apparatus and method for effectively performing full-duplex (FD)-based communication in an unlicensed band in a wireless communication system.

The present disclosure may provide an apparatus and method for performing a channel access procedure (CAP) operation in another channel during a transmission operation in any one channel in an unlicensed band in a wireless communication system.

The present disclosure may provide an apparatus and method for configuring a subband or a bandwidth part (BWP) for FD-based communication in a wireless communication system.

The present disclosure may provide an apparatus and method for configuring a subband or a BWP for FD-based communication by considering performance of a CAP in an unlicensed band in a wireless communication system.

The present disclosure may provide an apparatus and method for configuring a subband or a BWP for FD-based communication in a channel unit of an unlicensed band in a wireless communication system.

The present disclosure may provide an apparatus and method for determining a communication direction based on a CAP result in an unlicensed band in a wireless communication system.

The present disclosure may provide an apparatus and method for adaptively adjusting an energy detection (ED) threshold for a CAP in an unlicensed band in a wireless communication system.

The present disclosure may provide an apparatus and method for differently determining an ED threshold for a CAP in an unlicensed band in a wireless communication system according to whether or not an FD operation is operated.

The present disclosure may provide an apparatus and method for defining an operation of each CAP type in an unlicensed band by considering an FD operation in a wireless communication system.

The present disclosure may provide an apparatus and method for determining a channel occupancy time (COT) by considering a CAP success time of each channel set for a multi-channel CAP in a wireless communication system.

Technical objects to be achieved in the present disclosure are not limited to what is mentioned above, and other technical objects not mentioned therein can be considered from the embodiments of the present disclosure to be described below by those skilled in the art to which a technical configuration of the present disclosure is applied.

As an example of the present disclosure, a method for operating a base station in a wireless communication system may include transmitting system information including information related to a communication band, transmitting configuration information related to distinguishing an uplink resource and a downlink resource in the communication band, based on at least one of the system information or the configuration information, performing a first channel access procedure (CAP) for a first channel and a second channel included in the communication band, based on the first CAP being successful in the first channel, transmitting a signal in the first channel, and performing a second CAP for the second channel during transmission of the signal in the first channel. The configuration information may indicate a size or a location of a frequency band, in which a full-duplex (FD) operation is allowed, by using a number of channels, which is a unit of performing the CAP, or a bitmap of which each bit corresponds to a channel that is a unit of performing the CAP.

As an example of the present disclosure, a base station in a wireless communication may include a transceiver and a processor coupled with the transceiver, and the processor may be configured to transmit system information including information related to a communication band, to transmit configuration information related to distinguishing an uplink resource and a downlink resource in the communication band, based on at least one of the system information or the configuration information, to perform a first channel access procedure (CAP) for a first channel and a second channel included in the communication band, based on the first CAP being successful in the first channel, to transmit a signal in the first channel, and to perform a second CAP for the second channel during transmission of the signal in the first channel. The configuration information may indicate a size or a location of a frequency band, in which a full-duplex (FD) operation is allowed, by using a number of channels, which is a unit of performing the CAP, or a bitmap of which each bit corresponds to a channel that is a unit of performing the CAP.

As an example of the present disclosure, a communication device may include at least one processor and at least one computer memory coupled with the at least one processor and storing an instruction that instructs operations when executed by the at least one processor, and the operations may include transmitting system information including information related to a communication band, transmitting configuration information related to distinguishing an uplink resource and a downlink resource in the communication band, based on at least one of the system information or the configuration information, performing a first channel access procedure (CAP) for a first channel and a second channel included in the communication band, based on the first CAP being successful in the first channel, transmitting a signal in the first channel, and performing a second CAP for the second channel during transmission of the signal in the first channel. The configuration information may indicate a size or a location of a frequency band, in which a full-duplex (FD) operation is allowed, by using a number of channels, which is a unit of performing the CAP, or a bitmap of which each bit corresponds to a channel that is a unit of performing the CAP.

As an example of the present disclosure, a non-transitory computer-readable medium storing at least one instruction may include the at least one instruction that is executable by a processor, and the at least one instruction may control a device to transmit system information including information related to a communication band, to transmit configuration information related to distinguishing an uplink resource and a downlink resource in the communication band, based on at least one of the system information or the configuration information, to perform a first channel access procedure (CAP) for a first channel and a second channel included in the communication band, based on the first CAP being successful in the first channel, to transmit a signal in the first channel, and to perform a second CAP for the second channel during transmission of the signal in the first channel. The configuration information may indicate a size or a location of a frequency band, in which a full-duplex (FD) operation is allowed, by using a number of channels, which is a unit of performing the CAP, or a bitmap of which each bit corresponds to a channel that is a unit of performing the CAP.

The above-described aspects of the present disclosure are merely a part of exemplary embodiments of the present disclosure, and various embodiments reflecting technical features of the present disclosure may be derived and understood by those skilled in the art based on the detailed description of the present disclosure below.

As is apparent from the above description, the embodiments of the present disclosure have the following effects.

According to the present disclosure, full-duplex-based communication can be effectively performed in an unlicensed band.

It will be appreciated by persons skilled in the art that that the effects that can be achieved through the embodiments of the present disclosure are not limited to those described above and other advantageous effects of the present disclosure will be more clearly understood from the following detailed description. That is, unintended effects according to implementation of the present disclosure may be derived by those skilled in the art from the embodiments of the present disclosure.

### BRIEF DESCRIPTION OF THE DRAWINGS

The accompanying drawings are provided to aid understanding of the present disclosure, and embodiments of the present disclosure may be provided together with a detailed description. However, the technical features of the present disclosure are not limited to a specific drawing, and features disclosed in each drawing may be combined with each other to constitute a new embodiment. Reference numerals in each drawing may mean structural elements.

FIG. 1 illustrates an example of a structure of a wireless communication system to which the present disclosure may be applied.

FIG. 2 illustrates an example of a wireless device applicable to the present disclosure.

FIG. 3 illustrates a frame structure in a wireless communication system to which the present disclosure may be applied.

FIG. 4 illustrates an example of a resource grid in a wireless communication system to which the present disclosure may be applied.

FIG. 5 illustrates an example of a physical resource block in a wireless communication system to which the present disclosure may be applied.

FIG. 6 illustrates an example of a slot structure in a wireless communication system to which the present disclosure may be applied.

FIG. 7 illustrates examples of physical channels used in a wireless communication system, to which the present disclosure may be applied, and an example of a general signal transmission and reception method using the physical channels.

FIG. 8A and FIG. 8B illustrate an example of a wireless communication system supporting an unlicensed band that is applicable to the present disclosure.

FIG. 9 illustrates a flowchart of a channel access procedure (CAP) operation for downlink signal transmission of a base station through an unlicensed band.

FIG. 10 illustrates a flowchart of a Type 1 CAP operation of a terminal for uplink signal transmission.

FIG. 11 illustrates an example of a single resource element group (REG) structure.

FIG. 12 illustrates an example of a non-interleaved CCE-REG mapping type.

FIG. 13 illustrates an example of an interleaved CCE-REG mapping type.

FIG. 14 illustrates an example of a block interleaver.

FIG. 15 illustrates an example of a network initial access and communication procedure that is applicable to the present disclosure.

FIG. 16 illustrates an example of full-duplex communication between carriers that is applicable to the present disclosure.

FIG. 17A and FIG. 17B illustrate an example of coexistence of a time resource with half-duplex (HD) operation and a time resource with FD operation, which is applicable to the present disclosure.

FIG. 18 illustrates an example of a CAP operation for communication in an unlicensed band that is applicable to the present disclosure.

FIG. 19 illustrates another example of a CAP operation for communication in an unlicensed band that is applicable to the present disclosure.

FIG. 20 illustrates an example of a procedure of applying an FD operation to an unlicensed band in a wireless communication system according to an embodiment of the present disclosure.

FIG. 21 illustrates an example of a procedure of transmitting a signal by using an unlicensed band in a wireless communication system according to an embodiment of the present disclosure.

FIG. 22 illustrates an example of a procedure of determining a link direction of a channel in an unlicensed band in a wireless communication system according to an embodiment of the present disclosure.

FIG. 23 illustrates an example of a procedure of determining availability of a channel in an unlicensed band in a wireless communication system according to an embodiment of the present disclosure.

FIG. 24 illustrates an example of adjustment of a backoff counter value for a CAP in a wireless communication system according to an embodiment of the present disclosure.

FIG. 25 illustrates an example of a procedure of transmitting a signal according to a channel occupancy time in a wireless communication system according to an embodiment of the present disclosure.

FIG. 26 illustrates an example of another procedure of transmitting a signal according to a channel occupancy time in a wireless communication system according to an embodiment of the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an advanced base station (ABS), an access point, etc.

In the embodiments of the present disclosure, the term terminal may be replaced with a UE, a mobile station (MS), a subscriber station (SS), a mobile subscriber station (MSS), a mobile terminal, an advanced mobile station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

3GPP 6G may mean a post-3GPP NR technology based on a 3GPP system. 3GPP 6G may not limited to a Release or a specific TS document, and its name may have a different form from 3GPP 6G. That is, 3GPP 6G may mean a technology introduced after 3GPP NR and is not limited to a specific form.

The description below will mainly focus on a 3GPP NR system but is not limited thereto and may be applied to 3GPP 6G. Furthermore, what is described below may be partially modified to be used in consideration of a 3GPP 6G system and is not limited to a specific form. However, hereinafter, for convenience of explanation, the 3GPP NR system will be mainly described. For background arts, terms, abbreviations, etc. used in the present disclosure, refer to matters described in the standard documents published prior to the present disclosure. For example, reference may be made to the standard documents 36.xxx and 38.xxx.

### Overall System

As more communication devices require larger communication capacities, the need for mobile broadband communication more enhanced than the existing Radio Access Technology (RAT) is on the rise. In addition, massive machine type communication (MTC), which provides a variety of services anytime and anywhere by connecting a plurality of devices and things, is also one of main issues worthy of consideration in next-generation communication. Furthermore, a communication system design considering a service/a terminal sensitive to reliability and latency is also under discussion. Thus, introduction of a next-generation RAT considering enhanced mobile broadband communication (eMBB), massive MTC (mMTC), ultra-reliable and low latency communication (URLLC) and the like is under discussion, and for convenience, a corresponding technology is referred to as NR in the present disclosure. NR is an expression which represents an example of a 5G RAT.

A new RAT system including NR uses an OFDM transmission method or a similar transmission method. The new RAT system may follow OFDM parameters different from OFDM parameters of LTE. Alternatively, the new RAT system may follow a numerology of the existing LTE/LTE-A as it is but support a wider system bandwidth (e.g., 100 MHz). Alternatively, one cell may support a plurality of numerologies. In other words, terminals which operate in accordance with different numerologies may coexist in one cell.

A numerology corresponds to one subcarrier spacing in a frequency domain. As a reference subcarrier spacing is scaled by an integer N, a different numerology may be defined.

In addition, a new RAT system including 6G may be considered as a next-generation RAT. The new RAT system including 6G may consider i) very high data speed per device, ii) a large number of connected devices, iii) global connectivity, iv) very low latency, v) reduction of energy consumption of battery-free IoT devices, vi) ultra-high reliability connection, and vii) a connected intelligence with machine learning ability, but is not limited thereto. The new RAT system including 6G may consider using a terahertz (THz) frequency band, that is, a frequency higher than an NR system, for a wider bandwidth and a higher transmission speed in consideration of what is described above. The RAT system including 6G may overcome an existing limitation by applying artificial intelligence/machine learning (AI/ML), but may not be limited thereto.

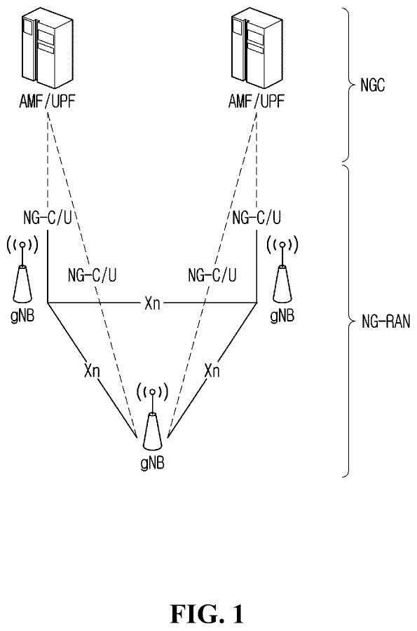

FIG. 1 exemplifies a structure of a wireless communication system to which the present disclosure may be applied. Referring to FIG. 1, NG-RAN consists of gNBs that provide control plane (RRC) protocol terminations for a NG-Radio Access (NG-RA) user plane (that is, a new access stratum (AS) sublayer/packet data convergence protocol (PDCP)/radio link control (RLC)/MAC/PHY) and a UE. The gNBs are interconnected through a Xn interface. In addition, the gNBs are connected to a new generation core (NGC) through an N2 interface. More specifically, the gNBs are connected to a access and mobility management function (AMF) through an N2 interface and are connected to a user plane function (UPF) through an N3 interface. FIG. 1 may be a structure based on an NR system, the structure of FIG. 1 may be used in a 6G system either as it is or by being partially modified and is not limited to a specific form.

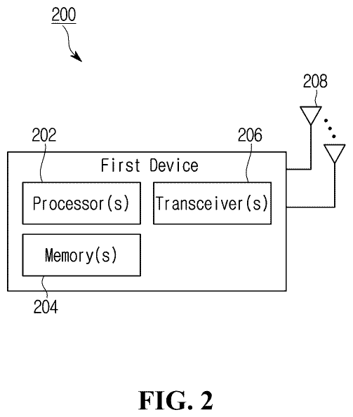

FIG. 2 illustrates an example of a wireless device applicable to the present disclosure.

Referring to FIG. 2, a wireless device 200 may transmit/receive a radio signal through various wireless access technologies (e.g., LTE, LTE-A, LTE-A pro, NR, 5G, 5G-A, 6G). The wireless device 200 may include at least one processor 202 and at least one memory 204 and additionally further include at least one transceiver 206 and/or at least one antenna 208.

The processor 202 may be configured to control the memory 204 and/or the transceiver 206 and to implement the descriptions, functions, procedures, proposals, methods, and/or operation flowcharts disclosed in this document. For example, the processor 202 may generate first information/signal by processing information in the memory 204 and then transmit a radio signal including the first information/signal through the transceiver 206. In addition, the processor 202 may receive a radio signal including second information/signal through the transceiver 206 and then store information obtained from signal processing of the second information/signal in the memory 204. The memory 204 may be connected to the processor 202 and store a variety of information associated with an operation of the processor 202. For example, the memory 204 may store a software code including instructions for implementing some or all of processes controlled by the processor 202 or for implementing the descriptions, functions, procedures, proposals, methods, and/or operation flowcharts disclosed in this document. Herein, the processor 202 and the memory 204 may be a part of a communication modem/circuit/chip designed for implementing a wireless communication technology. The transceiver 206 may be connected to the processor 202 and transmit and/or receive a radio signal through the at least one antenna 208. The transceiver 206 may be a transmitter and/or a receiver. The transceiver 206 may be used interchangeably with a radio frequency (RF) unit. In the present disclosure, a wireless device may mean a communication modem/circuit/chip.

Hereinafter, a hardware element of the wireless device 200 will be described in further detail. Although not being limited thereto, at least one protocol layer may be implemented by the at least one processor 202. For example, the at least one processor 202 may implement at least one layer (e.g., a functional layer such as physical (PHY), media access control (MAC), radio link control (RLC), packet data convergence protocol (PDCP), radio resource control (RRC), and service data adaptation protocol (SDAP)). The at least one processor 202 may generate at least one protocol data unit (PDU) and/or at least one service data unit (SDU) according to the descriptions, functions, procedures, proposals, methods, and/or operation flowcharts disclosed in this document. The at least one processor 202 may generate a message, control information, data, or information according to the descriptions, functions, procedures, proposals, methods, and/or operation flowcharts disclosed in this document. The at least one processor 202 may generate a signal (e.g., a baseband signal) including a PDU, an SDU, a message, control information, data, or information according to a function, a procedure, a suggestion and/or a method, which are disclosed in the present document, and provide the signal to the at least one transceiver 206. The at least one processor 202 may receive a signal (e.g., a baseband signal) from the at least one transceiver 206 and obtain a PDU, an SDU, a message, control information, data, or information according to the descriptions, functions, procedures, proposals, methods, and/or operation flowcharts disclosed in this document.

The at least one processor 202 may be referred to as a controller, a microcontroller, a microprocessor, or a microcomputer. The at least one processor 202 may be implemented by hardware, firmware, software, or a combination thereof. As an example, at least one application specific integrated circuit (ASIC), at least one digital signal processor (DSP), at least one digital signal processing devices (DSPD), at least one programmable logic device (PLD), or at least one field programmable gate array (FPGA) may be included in the at least one processor 202. The descriptions, functions, procedures, proposals, methods, and/or operation flowcharts disclosed in this document may be implemented using firmware or software, and the firmware or software may be implemented to include the modules, procedures, or functions. Firmware or software configured to perform the descriptions, functions, procedures, proposals, methods, and/or operation flowcharts disclosed in this document may be included in the at least one processor 202 or may be stored in the at least one memory 204 and executed by the at least one processor 202. The descriptions, functions, procedures, proposals, methods, and/or operation flowcharts disclosed in this document may be implemented using firmware or software in the form of code, an instruction, and/or a set of instructions.

The at least one memory 204 may be connected to the at least one processor 202 and store various forms of data, signals, messages, information, programs, codes, indications, and/or instructions. The at least one memory 204 may be configured as a read only memory (ROM), a random access memory (RAM), an erasable programmable read only memory (EPROM), a flash memory, a hard drive, a register, a cache memory, a computer-readable storage media, and/or a combination thereof. The at least one memory 204 may be located at the interior and/or exterior of the at least one processor 202. In addition, the at least one memory 204 may be connected to the at least one processor 202 through various technologies such as wired or wireless connection.

The at least one transceiver 206 may transmit user data, control information, and wireless signals/channels, mentioned in the methods and/or operation flowcharts of this document, to at least one other device. The at least one transceiver 206 may receive user data, control information, and wireless signals/channels, mentioned in the descriptions, functions, procedures, proposals, methods, and/or operation flowcharts disclosed in this document, from at least one other device. For example, the at least one transceiver 206 may be connected to the at least one processor 202 and transmit and receive radio signals. For example, the at least one processor 202 may control the at least one transceiver 206 to transmit user data, control information, or a radio signal to at least one other device. In addition, the at least one processor 202 may control the at least one transceiver 206 to receive user data, control information, or a radio signal from at least one other device. In addition, the at least one transceiver 206 may be connected to the at least one antenna 208, and the at least one transceiver 206 may be configured to transmit and receive user data, control information, radio signals/channels mentioned in the descriptions, functions, procedures, proposals, methods and/or operation flowcharts disclosed in this document through the at least one antenna 208. In this document, the at least one antenna may be a plurality of physical antennas or a plurality of logical antennas (e.g., antenna ports). The at least one transceiver 206 may convert received radio signals/channels from RF band signals into baseband signals in order to process received user data, control information, and radio signals/channels using the at least one processor 202. The at least one transceiver 206 may convert the user data, control information, and radio signals/channels processed using the at least one processor 202 from the baseband signals into the RF band signals. To this end, the at least one transceiver 206 may include an (analog) oscillator and/or a filter.

The constituents of the wireless device, which are described in reference to FIG. 2, may be referred to as other terms from functional aspects. For example, the processor 202 may be referred to as a control unit, the transceiver 206 may be referred to as a communication unit, and the memory 204 may be referred to as a storage unit. In some cases, the communication unit may be used for a meaning including at least a part of the processor 202 and the transceiver 206.

The structure of the wireless device, which is described in reference to FIG. 2, may be understood as a structure of at least a part of various devices. As an example, the structure may be at least a part of various devices (e.g., a robot, a vehicle, an XR device, a hand-held device, a home appliance, an IoT device, an AI device/a server, etc.). Furthermore, according to various embodiments, apart from the constituents exemplified in FIG. 2, a device may further other constituents.

For example, a device may be a hand-held device such as a smartphone, a smart pad, a wearable device (e.g., a smart watch, smart glasses), and a hand-held computer (e.g., a laptop, etc.). In this case, the device may further include at least one of a power supply unit that supplies power and includes a wired/wireless charging circuit, a battery and the like, an interface unit including at least one port (e.g., an audio input/output port, a video input/output port) for connection to another device, and an input/output unit for inputting and outputting video information/signals, audio information/signals, data and/or information input from a user.

For example, a device may be a mobile device such as a mobile robot, a vehicle, a train, a manned/unmanned aerial vehicle (AV), and a ship. In this case, the device may further include at least one of a drive unit including at least one of the engine, motor, powertrain, wheels, brake, and steering device of the device, a power supply unit that supplies power and includes a wired/wireless charging circuit, a battery and the like, a sensor unit that senses state information of the device or surrounding the device, environment information and user information, an autonomous driving unit that performs functions such as route maintenance, speed control and destination setting, and a location measurement unit that obtains moving object location information through a global positioning system (GPS) and various sensors.

For example, a device may be an XR device such as an HMD, a head-up display (HUD) provided in a vehicle, a television, a smartphone, a wearable device, a home appliance device, a digital signage, a vehicle, and a robot. In this case, the device may further include at least one of a power supply unit that supplies power and includes a wired/wireless charging circuit, a battery and the like, an input/output unit that obtains control information and data from outside and outputs a generated XR object, and a sensor unit that senses state information of the device or surrounding the device, environment information and user information.

For example, a device may be a robot that may be classified for industrial use, medical use, domestic use, military use and the like according to purposes of use or fields. In this case, the device may further include at least one of a sensor unit that senses state information of the device or surrounding the device, environment information and user information and a drive unit that moves robot joints and performs various other physical operations.

For example, a device may be an AI device such as a TV, a projector, a smartphone, a PC, a laptop, a terminal for digital broadcasting, a tablet PC, a wearable device, a set-top box (STB), a radio, a washing machine, a refrigerator, a digital signage, a robot, and a vehicle. In this case, the device may further include at least one of an input unit that obtains various types of data from outside, an output unit that generates outputs associated with sight, hearing, or touch, a sensor unit that senses state information of the device or surrounding the device, environment information and user information, and a training unit that uses learning data to learn a model consisting of artificial neural networks. The structure of the wireless device exemplified in FIG. 2 may be understood as a part of a RAN node (e.g., a base station, a DU, a RU, a RRH, etc.). That is, the device exemplified in FIG. 2 may be a RAN node. In this case, the device may further include a wired transceiver for front haul and/or back haul communication. However, in case the front haul and/or back haul communication is based on wireless communication, the at least one transceiver 206 exemplified in FIG. 2 may be used for the front haul and/or back haul communication, and no wired transceiver may be included.

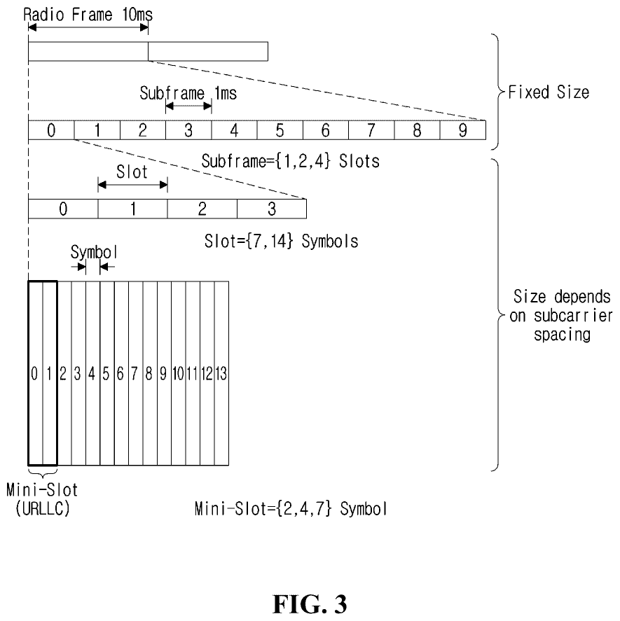

FIG. 3 exemplifies a frame structure in a wireless communication system to which the present disclosure may be applied.

A NR system may support a plurality of numerologies. Here, a numerology may be defined by a subcarrier spacing and a cyclic prefix (CP) overhead. Here, a plurality of subcarrier spacings may be derived by scaling a default (reference) subcarrier spacing by an integer N (or μ). In addition, although it is assumed that a very low subcarrier spacing is not used in a very high carrier frequency, a numerology used herein may be selected independently from a frequency band. In addition, a variety of frame structures according to a plurality of numerologies may be supported in a NR system.

Hereinafter, an OFDM numerology and frame structure which may be considered in a NR system will be described. A plurality of OFDM numerologies supported in a NR system may be defined as in the following Table 1.

TABLE 1

| μ | Δf = 2^{μ} · 15[kHz] | CP |
|---|---|---|
| 0 | 15 | Normal |
| 1 | 30 | Normal |
| 2 | 60 | Normal, Extended |
| 3 | 120 | Normal |
| 4 | 240 | Normal |

NR supports a plurality of numerologies (or subcarrier spacings (SCS)) for supporting a variety of 5G services. For example, when a SCS is 15 kHz, a wide area in traditional cellular bands is supported, and when a SCS is 30 kHz/60 kHz, a dense-urban area, lower latency and a wider carrier bandwidth are supported, and when a SCS is 60 kHz or higher, a bandwidth wider than 24.25 GHz is supported to overcome a phase noise.

An NR frequency band is defined as a frequency range in two types (FR1, FR2). FR1 and FR2 may be configured as in the following Table 2. In addition, FR2 may mean a millimeter wave (mmW).

TABLE 2

| Frequency Range | Corresponding frequency | |
|---|---|---|
| designation | range | Subcarrier spacing |
| FR1 | 410 MHz-7125 MHz | 15, 30, 60 kHz |
| FR2 | 24250 MHz-52600 MHz | 60, 120, 240 kHz |

Regarding a frame structure in an NR system, sizes of various fields in a time domain are expressed as multiples of a time unit of T_{c}=1/(Δfₘₐₓ·N_{f}) Here, Δfₘₐₓ is 480·10³ Hz and N_{f} is 4096. Downlink and uplink transmission is configured (organized) with a radio frame having a duration of T_{f}=1/(Δfₘₐₓ·N_{f}/100)T_{c}=10 ms. Here, the radio frame is configured with 10 subframes having a duration of T_{sf}=(Δfₘₐₓ·N_{f}/1000)T_{c}=1 ms, respectively. In this case, there may be one set of frames for an uplink and one set of frames for a downlink. In addition, transmission in an uplink frame No. i from a terminal should start earlier by T_{TA}=(N_{TA}+N_{TA,offset})T_{c} than a corresponding downlink frame in a corresponding terminal starts. For a subcarrier spacing configuration u, slots are numbered in an increasing order of

$${n}_{s}^{μ} ∈ \{ 0 , … , {N}_{slot}^{subframe , μ} - 1 \}$$

in a subframe and are numbered in an increasing order of

$${n}_{s , f}^{μ} ∈ \{ 0 , … , {N}_{slot}^{frame , μ} - 1 \}$$

in a radio frame. One slot is configured with

$${N}_{symb}^{slot}$$

consecutive OFDM symbols and

$${N}_{symb}^{slot}$$

is determined according to CP. A start of a slot

$${n}_{s}^{μ}$$

in a subframe is temporally arranged with a start of an OFDM symbol

$${n}_{s}^{μ} {N}_{symb}^{slot}$$

in the same subframe. All terminals may not perform transmission and reception at the same time, which means that not all OFDM symbols of a downlink slot or an uplink slot are available.

Table 3 represents the number of OFDM symbols per slot

$$( {N}_{symb}^{slot} ) ,$$

the number of slots per radio frame

$$( {N}_{slot}^{frame , μ} )$$

and the number of slots per subframe

$$( {N}_{slot}^{subframe , μ} )$$

in a normal CP and Table 4 represents the number of OFDM symbols per slot, the number of slots per radio frame and the number of slots per subframe in an extended CP.

TABLE 3

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 4

| μ | ${N}_{symb}^{slot}$ | ${N}_{slot}^{frame , μ}$ | ${N}_{slot}^{subframe , μ}$ |
|---|---|---|---|
| 2 | 12 | 40 | 4 |

FIG. 3 is an example on μ=2 (SCS is 60 kHz), and referring to Table 3, 1 subframe may include 4 slots. 1 subframe={1,2,4} slot shown in FIG. 3 is an example, and the number of slots which may be included in 1 subframe is defined as in Table 3 or Table 4. In addition, a mini-slot may include 2, 4 or 7 symbols or more or less symbols.

Regarding a physical resource in a NR system, an antenna port, a resource grid, a resource element, a resource block, a carrier part and the like may be considered. Hereinafter, the physical resources which may be considered in an NR system will be described in detail.

First, in relation to an antenna port, an antenna port is defined so that a channel where a symbol in an antenna port is carried can be inferred from a channel where another symbol in the same antenna port is carried. When a large-scale property of a channel where a symbol in one antenna port is carried may be inferred from a channel where a symbol in another antenna port is carried, it may be said that the two antenna ports are in a quasi co-located or quasi co-location (QC/QCL) relationship. In this case, the large-scale property includes one or more of delay spread, doppler spread, frequency shift, average received power, and received timing.

In a 6G system, communication may be performed at the above-described THz band that is higher than millimeter wave (mmW) frequency, and the same frame structure as shown in FIG. 3 may be used or a separate frame structure for the 6G system may be used but is not limited to a specific form.

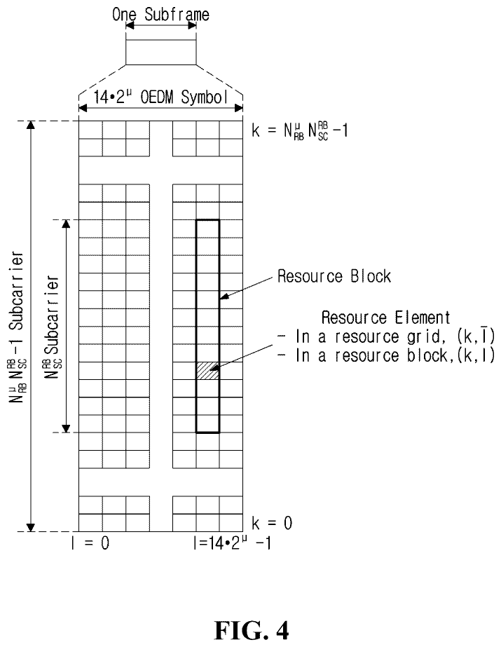

FIG. 4 exemplifies a resource grid in a wireless communication system to which the present disclosure may be applied.

Referring to FIG. 4, as an illustrative description, a resource grid is configured with

$${N}_{RB}^{μ} {N}_{SC}^{RB}$$

subcarriers in a frequency domain, and one subframe is configured with 14·2^{μ} OFDM symbols, but the resource grid and the subframe are not limited thereto. In an NR system, a transmitted signal is described by one or more resource grids configured with

$${2}^{μ} {N}_{symb}^{( μ )}$$

OFDM symbols and

$${N}_{RB}^{μ} {N}_{SC}^{RB}$$

subcarriers. Here,

$${N}_{RB}^{μ} \leq {N}_{RB}^{max , μ} .$$

### The

$${N}_{RB}^{max , μ}$$

represents a maximum transmission bandwidth, which may be different between an uplink and a downlink as well as between numerologies. In this case, one resource grid may be configured per μ and antenna port p. Each element of a resource grid for μ and an antenna port p is referred to as a resource element and is uniquely identified by an index pair (k, l′). Here, k=0, . . . ,

$${N}_{RB}^{μ} {N}_{SC}^{RB} - 1$$

is an index in a frequency domain and l′=0, . . . ,

$${2}^{μ} {N}_{symb}^{( μ )} - 1$$

refers to a position of a symbol in a subframe. When referring to a resource element in a slot, an index pair (k, l) is used. Here, l=0, . . . ,

$${2}^{μ} {N}_{symb}^{( μ )} - 1.$$

A resource element (k, l′) for μ and an antenna port p corresponds to a complex value,

$${a}_{k , f}^{( p , μ )} .$$

When there is no risk of confusion or when a specific antenna port or numerology is not specified, indexes p and μ may be dropped, whereupon a complex value may be

$${a}_{k , {l}^{′}}^{( p )} or {a}_{k , {l}^{′}} .$$

In addition, a resource block (RB) is defined as

$${N}_{sc}^{RB} = 12$$

consecutive subcarriers in a frequency domain.

Point A plays a role as a common reference point of a resource block grid and is obtained as follows.
offsetToPointA for a primary cell (PCell) downlink represents a frequency offset between point A and a lowest subcarrier of a lowest resource block overlapping with a SS/PBCH block which is used by a terminal for initial cell selection. It is expressed in resource block units assuming a 15 kHz subcarrier spacing for FR1 and a 60 kHz subcarrier spacing for FR2.
absoluteFrequency PointA represents a frequency-position of point A expressed as in an absolute radio-frequency channel number (ARFCN).

Common resource blocks are numbered from 0 to the top in a frequency domain for a subcarrier spacing configuration μ. The center of subcarrier 0 of common resource block 0 for a subcarrier spacing configuration μ is identical to ‘point A’. A relationship between a common resource block number

$${n}_{CRB}^{μ}$$

and a resource element (k, l) for a subcarrier spacing configuration μ in a frequency domain is given as in the following Equation 1.

$${n}_{CRB}^{μ} = ⌊ \frac{k}{{N}_{sc}^{RB}} ⌋ \qquad [ Equation 1 ]$$

In Equation 1, k is defined relatively to point A so that k=0 corresponds to a subcarrier centering around point A. Physical resource blocks are numbered from 0 to

$${N}_{BWP , i}^{size , μ} - 1$$

in a bandwidth part (BWP) and i is the number of a BWP. A relationship between a physical resource block n_{PRB} and a common resource block n_{CRB} in BWP i is given by the following Equation 2.

$${n}_{CRB}^{μ} = {n}_{PRB}^{μ} + {N}_{BWP , i}^{start , μ} \qquad [ Equation 2 ]$$

$${N}_{BWP , i}^{start , μ}$$

is a common resource block that a BWP starts relatively to common resource block 0.

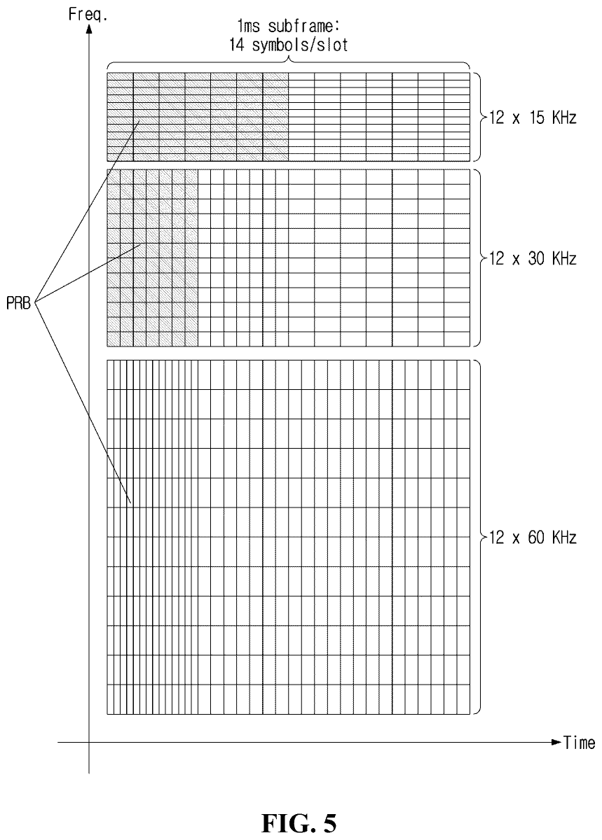

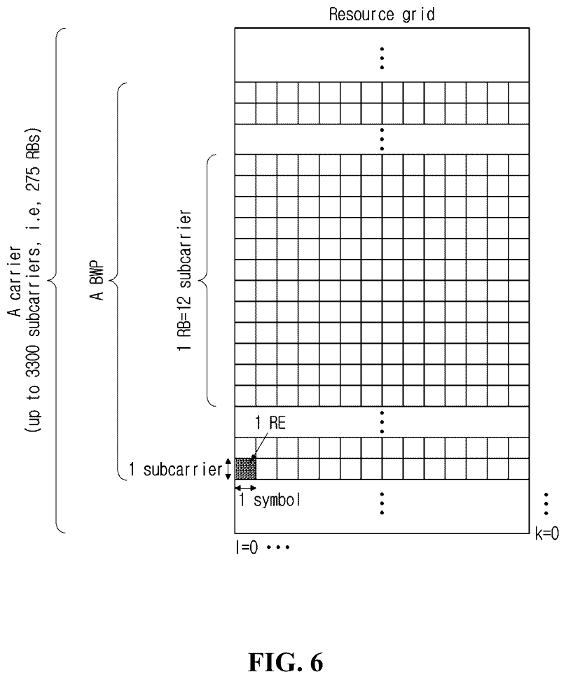

FIG. 5 exemplifies a physical resource block in a wireless communication system to which the present disclosure may be applied. In addition, FIG. 6 exemplifies a slot structure in a wireless communication system to which the present disclosure may be applied.

Referring to FIG. 5 and FIG. 6, a slot includes a plurality of symbols in a time domain. For example, for a normal CP, one slot includes 7 symbols, but for an extended CP, one slot includes 6 symbols.

A carrier includes a plurality of subcarriers in a frequency domain. A resource block (RB) is defined as a plurality of (e.g., 12) consecutive subcarriers in a frequency domain. A bandwidth part (BWP) is defined as a plurality of consecutive (physical) resource blocks in a frequency domain and may correspond to one numerology (e.g., an SCS, a CP length, etc.). A carrier may include a maximum of N (e.g., 5) BWPs. Data communication may be performed through an activated BWP and only one BWP may be activated for one terminal. In a resource grid, each element is referred to as a resource element (RE) and one complex symbol may be mapped.

In an NR system, up to 400 MHz may be supported per component carrier (CC). In case a terminal operating in such a wideband CC always operates with a radio frequency (FR) chip for the whole CC being turned on, terminal battery consumption may increase. Alternatively, when several application cases operating in one wideband CC (e.g., eMBB, URLLC, Mmtc, V2X, etc.) are considered, a different numerology (e.g., a subcarrier spacing, etc.) may be supported per frequency band in a corresponding CC. Alternatively, each terminal may have a different capability for the maximum bandwidth. In this regard, a base station may instruct a terminal to operate only in a partial bandwidth, not in an overall bandwidth of a wideband CC, and a corresponding partial bandwidth is defined as a bandwidth part (BWP) for convenience. A BWP may be configured with consecutive RBs on a frequency axis and may correspond to one numerology (e.g., a subcarrier spacing, a CP length, a slot/a mini-slot duration).

Meanwhile, a base station may configure a plurality of BWPs even in one CC configured for a terminal. For example, a BWP occupying a relatively small frequency domain may be configured in a PDCCH monitoring slot, and a PDSCH indicated by a PDCCH may be scheduled in a greater BWP. Alternatively, when UEs are congested in a specific BWP, some terminals may be configured with another BWP for load balancing. Alternatively, considering frequency domain inter-cell interference cancellation between neighboring cells and the like, some middle spectrums of a whole bandwidth may be excluded and BWPs on both edges may be configured in the same slot. In other words, a base station may configure at least one DL/UL BWP for a terminal associated with a wideband CC. A base station may activate at least one DL/UL BWP of configured DL/UL BWP(s) at a specific time (by L1 signaling or MAC control element (CE) or RRC signaling, etc.). In addition, a base station may indicate switching to another configured DL/UL BWP (by L1 signaling or MAC CE or RRC signaling, etc.). Alternatively, based on a timer, when a timer value is expired, it may be switched to a determined DL/UL BWP. Herein, an activated DL/UL BWP is defined as an active DL/UL BWP. However, a configuration on a DL/UL BWP may not be received when a terminal performs an initial access procedure or a RRC connection has not been set up yet, so a DL/UL BWP which is assumed by the terminal in such a situation is defined as an initial active DL/UL BWP.

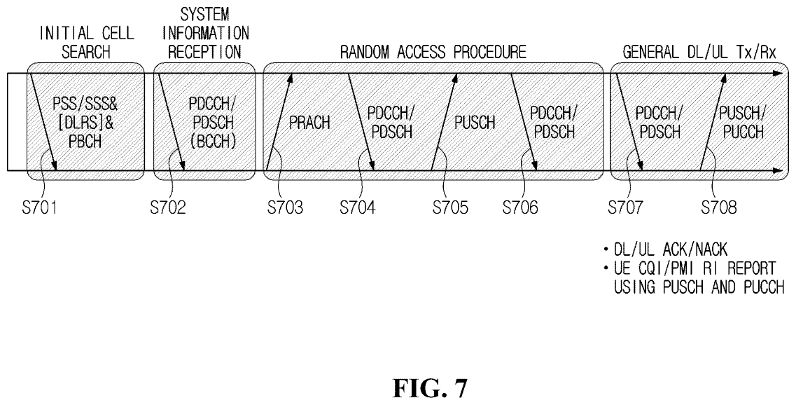

FIG. 7 exemplifies physical channels used in a wireless communication system, to which the present disclosure may be applied, and a general signal transmission and reception method using the physical channels.

In a wireless communication system, a terminal receives information from a base station through a downlink, and the terminal transmits information to the base station through an uplink. Information transmitted and received by the base station and the terminal includes data and a variety of control information, and a variety of physical channels exist according to a type/a usage of information transmitted and received by them.

When a terminal is turned on or newly enters a cell, the terminal performs an initial cell search including synchronization with a base station (S701). To this end, the terminal may synchronize with the base station by receiving a primary synchronization signal (PSS) and a secondary synchronization signal (SSS) from the base station and obtain information such as a cell identifier (ID) and the like. Next, the terminal may obtain broadcasting information in a cell by receiving a physical broadcast channel (PBCH) from the base station. Meanwhile, the terminal may check out a downlink channel state by receiving a downlink reference signal (DL RS) at the initial cell search step.

The terminal, which has completed initial cell search, may obtain more detailed system information by receiving a physical downlink control channel (PDCCH) and a physical downlink shared channel (PDSCH) according to information carried in the PDCCH (S702).

Meanwhile, in case the terminal accesses to the base station for the first time or does not have a radio resource for signal transmission, the terminal may perform a random access procedure (RACH) for the base station (S703 to S706). To this end, the terminal may transmit a specific sequence as a preamble through a physical random access channel (PRACH) (S703 and S705) and receive a response message for the preamble through a PDCCH and a corresponding PDSCH (S704 and S706). In the case of a contention-based RACH, a contention resolution procedure may be additionally performed.

The terminal, which has performed the above-described procedure, may subsequentially perform PDCCH/PDSCH reception (S707) and physical uplink shared channel (PUSCH)/physical uplink control channel (PUCCH) transmission (S708) as a general uplink/downlink signal transmission procedure. In particular, the terminal receives downlink control information (DCI) through a PDCCH. Herein, the DCI includes control information such as resource allocation information for the terminal and has a different format depending on its purpose of use.

Meanwhile, control information, which is transmitted by the terminal to the base station through an uplink or is received by the terminal from the base station, includes a downlink/uplink acknowledgement/non-acknowledgement (ACK/NACK) signal, a channel quality indicator (CQI), a precoding matrix indicator (PMI), a rank indicator (RI), and the like. For a 3GPP LTE system, the terminal may transmit control information of the above-described CQI/PMI/RI and the like through a PUSCH and/or a PUCCH.

### Wireless Communication System Supporting Unlicensed Band

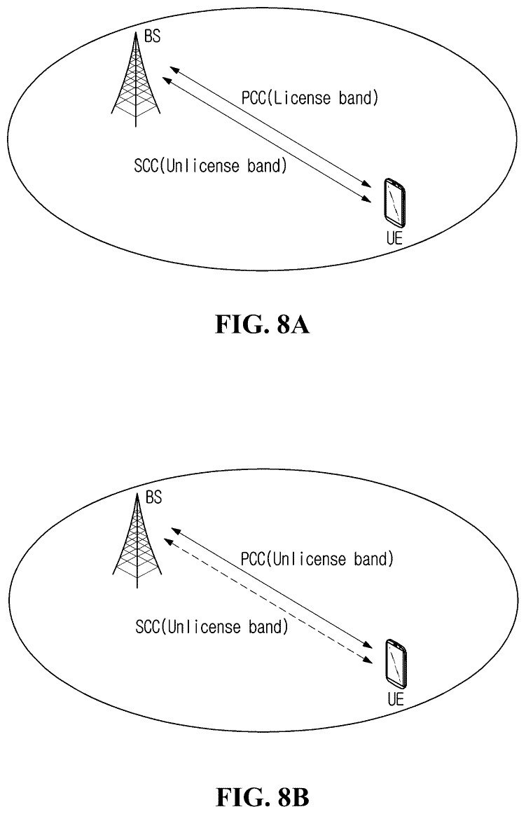

FIG. 8A and FIG. 8B illustrate an example of a wireless communication system supporting an unlicensed band that is applicable to the present disclosure. In the description below, a cell operating in a licensed band (hereinafter, L-band) is defined as an L-cell, and a carrier of the L-cell is defined as a (DL/UL) LCC. In addition, a cell operating in an unlicensed band (hereinafter, U-band) is defined as a U-cell, and a carrier of the U-cell is defined as a (DL/UL) UCC. A carrier/carrier-frequency of a cell may mean an operation frequency of the cell (e.g., center frequency). Cell/carrier (e.g. CC) is collectively referred to as cell.

In case carrier aggregation is supported, one terminal may perform transmission/reception of a signal with a base station through a plurality of aggregated cells/carriers. In case a plurality of CCs are configured in a single terminal, one CC may be set as a primary CC (PCC) and the remaining CCs may be set as a secondary CC (SCC). Particular control information/channel (e.g., CSS PDCCH, PUCCH) may be configured to be transmitted and received through a PCC. Data may be transmitted and received through a PCC/SCC. As shown in FIG. 8A, in case a terminal and a base station transmit and receive a signal through carrier-aggregated LCC and UCC (non-standalone (NSA) mode), the LCC may be set as a PCC and the UCC may be set as an SCC. In case a plurality of LCCs are configured in a terminal, one specific LCC may be set as a PCC, and the remaining LCCs may be set as an SCC. As shown in FIG. 8B, a terminal and a base station may transmit and receive a signal through a single UCC or a plurality of carrier-aggregated UCCs. That is, the terminal and the base station may transmit and receive a signal only through UCC(s) without LCC (SA mode). In this case, one of the UCCs may be set as a PCC and the remaining UCCs may be set as an SCC. In an unlicensed band of a 3GPP system, both NSA mode and SA mode may be supported.

Hereinafter, (unless otherwise stated) in the present disclosure, the above-described signal transmission/reception operation in an unlicensed band may be performed in all the above-described placement scenarios.

Hereinafter, in the present disclosure, the above-described carrier may also be described by being replaced by a channel.

### Downlink Signal Transmission Method Through Unlicensed Band

A base station may perform one of the following unlicensed band access procedures (e.g., channel access procedure (CAP)) to transmit a downlink signal in an unlicensed band.

### (1) First Downlink CAP Method

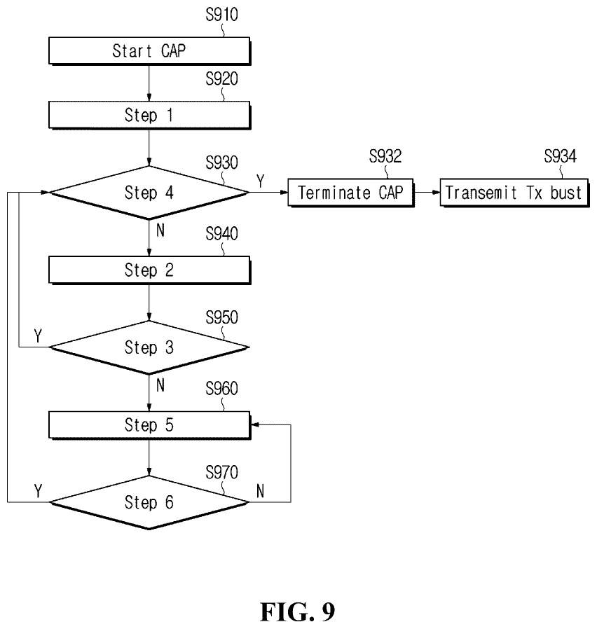

FIG. 9 illustrates a flowchart of a channel access procedure (CAP) operation for downlink signal transmission of a base station through an unlicensed band. For the downlink signal transmission through the unlicensed band (e.g., signal transmission including PDSCH/PDCCH), the base station may start a CAP (S910). The base station may randomly select a backoff counter N within a contention window (CW) according to Step 1. Herein, the value of N is set to an initial value Ninit (S920). Ninit is selected as an arbitrary value between 0 and CWp. Next, according to Step 4, if the backoff counter value N is 0 (Y of S930), the base station terminates the CAP (S932). Next, the base station may perform Tx burst transmission including a PDSCH/PDCCH (S934). On the other hand, if the backoff counter value is not 0 (N of S930), the base station decreases the backoff counter value by 1 according to Step 2 (S940). Next, the base station checks whether or not a channel of U-cell(s) is idle (S950), and if it is idle (Y of S950), the base station checks whether or not the backoff counter value is 0 (S930). On the other hand, at step S950, if the channel is not idle, that is, if the channel is busy (N of S950), the base station checks whether or not the channel is idle for a defer duration Td (longer than 25 usec) longer than a slot time (e.g., 9 usec) (S960). If the channel is idle for the defer duration (Y of S970), the base station may restart the CAP. Herein, the defer duration may consist of a 16 usec interval and immediate subsequent mp successive slot times (e.g., 9 usec). On the other hand, if the channel is busy for the defer duration (N of S970), the base station performs step S960 again and checks again whether or not the channel of U-cell(s) is idle for a new defer duration.

Table 5 exemplifies variations of mp, minimum CW, maximum CW, maximum channel occupancy time (MCOT) and allowed CW sizes, which are applied to a CAP, according to channel access priority classes.

TABLE 5

| Channel | | | | | |
|---|---|---|---|---|---|
| Access | | | | | |
| Priority | | | | | allowed CWₚ |
| Class (p) | mₚ | CW_{min, p} | CW_{max, p} | T_{mcot, p} | sizes |
| 1 | 1 | 3 | 7 | 2 ms | {3, 7} |
| 2 | 1 | 7 | 15 | 3 ms | {7, 15} |
| 3 | 3 | 15 | 63 | 8 or | {15, 31, 63} |
| | | | | 10 ms | |
| 4 | 7 | 15 | 1023 | 8 or | {15, 31, 63, 127, |
| | | | | 10 ms | 255, 511, 1023} |

A contention window size applied to a first downlink CAP may be determined based on various methods. As an example, the contention window size may be adjusted based on a probability in which HARQ-ACK values corresponding to PDSCH transmission(s) within a predetermined time interval (e.g., reference TU) are determined as NACK. In case a base station performs downlink signal transmission including a PDSCH related to a channel access priority class p in a carrier, if a probability, in which HARQ-ACK values corresponding to PDSCH transmission(s) within a reference time interval/occasion k (or reference slot k) are determined as NACK, is at least Z=80%, the base station increases CW values set for each priority class to each next allowed higher priority. Alternatively, the base station maintains CW values set for each priority class at an initial value. A reference time interval/occasion (or reference slot) may be defined as a start time interval/occasion (or start slot) on which a latest signal transmission is performed in a carrier for which at least partial HARQ-ACK feedback is available.

### (2) Second Downlink CAP Method

Based on the second downlink CAP method described below, a base station may perform downlink signal transmission through an unlicensed band (e.g., signal transmission including discovery signal transmission but not PDSCH).

In case a length of a signal transmission interval of a base station is equal or less than 1 ms, the base station may transmit a downlink signal (e.g., a signal including discovery signal transmission but not a PDSCH) through an unlicensed band immediately after a channel is sensed to be idle during at least a sensing interval T_{drs}=25 μs. Here, T_{drs} consists of one slot interval Tₛₗ=9 μs and an immediate following interval T_{f}(=16 μs).

### (3) Third Downlink CAP Method

A base station may perform the following CAP for downlink signal transmission through multiple carriers in an unlicensed band.
1) Type A: a base station performs a CAP for multiple carriers based on a counter N defined according to each carrier (counter N considered in the CAP) and performs downlink signal transmission based on the CAP.
   Type A1: the counter N of each carrier is independently determined, and downlink signal transmission through each carrier is performed based on the counter N of each carrier.
   Type A2: the counter N of each carrier is determined as an N value for a carrier with a largest contention window size, and downlink signal transmission through each carrier is performed based on the counter N of the carrier.
2) Type B: a base station performs a CAP based on the counter N only for a specific carrier among a plurality of carriers and performs downlink signal transmission by determining for remaining carriers whether or not a channel is idle, prior to signal transmission in the specific carrier.
   Type B1: a single contention window size is defined for a plurality of carriers, and a base station uses the single contention window size when performing a CAP based on the counter N for a specific carrier.
   Type B2: a contention window size is defined for each carrier, and a largest contention window size of contention window sizes is used to determine a value of Ninit for a specific carrier.

### Uplink Signal Transmission Method Through Unlicensed Band

A terminal performs a contention-based CAP for uplink signal transmission in an unlicensed band. The terminal performs a Type 1 or Type 2 CAP for uplink signal transmission in an unlicensed band. Generally, the terminal may perform a CAP configured by a base station (e.g., Type 1 or Type 2) for uplink signal transmission.

### (1) Type 1 Uplink CAP Method

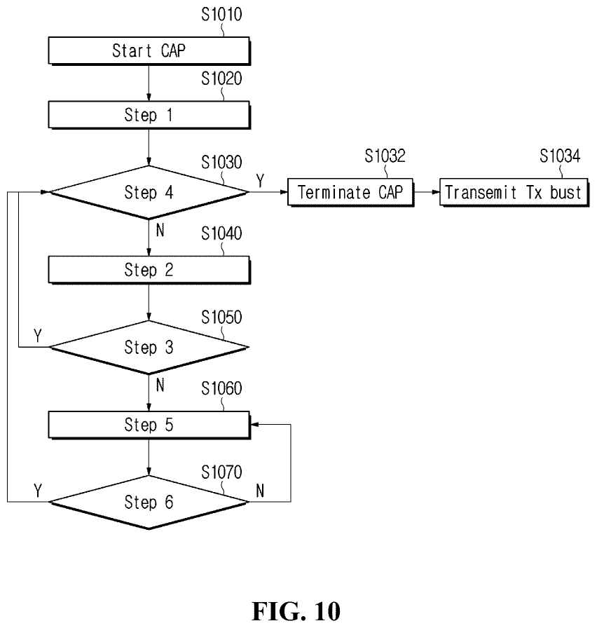

FIG. 10 illustrates a flowchart of a Type 1 CAP operation of a terminal for uplink signal transmission. The terminal may start a channel access procedure (CAP) for signal transmission through an unlicensed band (S1010). The terminal may randomly select a backoff counter N within a contention window (CW) according to Step 1. Herein, the value of N is set to an initial value Nᵢₙᵢₜ (S1020). Nᵢₙᵢₜ is selected as an arbitrary value between 0 and CWₚ. Next, according to Step 4, if the backoff counter value N is 0 (Y of S1030), the terminal terminates the CAP (S1032). Next, the terminal may perform Tx burst transmission including a PDSCH/PDCCH (S1034). On the other hand, if the backoff counter value is not 0 (N of S1030), the terminal decreases the backoff counter value by 1 according to Step 2 (S1040). Next, the terminal checks whether or not a channel of U-cell(s) is idle (S1050), and if it is idle (Y of S1050), the terminal checks whether or not the backoff counter value is 0 (S1030). On the other hand, at step S1050, if the channel is not idle, that is, if the channel is busy (N of S1050), the terminal checks whether or not the channel is idle for a defer duration Ta (longer than 25 usec) longer than a slot time (e.g., 9 usec) (S1060). If the channel is idle for the defer duration (Y of S1070), the terminal may restart the CAP. Herein, the defer duration may consist of a 16 usec interval and immediate subsequent mₚ successive slot times (e.g., 9 usec). On the other hand, if the channel is busy for the defer duration (N of S1070), the terminal performs step S1060 again and checks again whether or not the channel is idle for a new defer duration.

Table 6 exemplifies variations of mₚ, minimum CW, maximum CW, maximum channel occupancy time (MCOT) and allowed CW sizes, which are applied to a CAP, according to channel access priority classes.

TABLE 6

| Channel | | | | | |
|---|---|---|---|---|---|
| Access | | | | | |
| Priority | | | | | allowed CWₚ |
| Class (p) | mₚ | CW_{min, p} | CW_{max, p} | T_{ulmcot, p} | sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |

NOTE1:
For p = 3, 4, T_{ulmcot, p} = 10 ms if the higher layer parameter ‘absenceOfAnyOtherTechnology-r14’ indicates TRUE, otherwise, T_{ulmcot, p} = 6 ms.
NOTE 2:
When T_{ulmcot, p} = 6 ms it may be increased to 8 ms by inserting one or more gaps. The minimum duration of a gap shall be 100 μs. The maximum duration before including any such gap shall be 6 ms.

A contention window size applied to a Type 1 uplink CAP may be determined based on various methods. For example, the contention window size may be adjusted based on whether a new data indicator (NDI) value is toggled for at least one HARQ process related to HARQ_ID_ref that is an HARQ process ID of a UL-SCH within a predetermined time interval (e.g., reference TU). In case a terminal performs signal transmission by using a Type 1 channel access procedure related to a channel access priority class p in a carrier, if an NDI value for at least one HARQ process related to HARQ_ID_ref is toggled, the terminal sets CWₚ=CW_{min,p} for every priority class p∈{1,2,3,4}, and otherwise, the terminal increases CWₚ for every priority class p∈{1,2,3,4} to a next higher allowed value.

A reference time interval/occasion n_{ref} (or reference slot n_{ref}) is determined as follows.

In case a terminal receives a UL grant in a time interval/occasion (or slot) n_{g} and performs a transmission including UL-SCH starting from a time interval/occasion (or slot) no within time intervals/occasions (or slots) n₀, n₁, . . . , n_{w} and without gaps (here, a time interval/occasion (or slot) n_{w} is a latest time interval/occasion (or slot) preceding a time interval/occasion (or slot) n_{g}-3 in which the terminal transmits a UL-SCH based on a Type 1 CAP), a reference time interval/occasion (or slot) n_{ref} is the time interval/occasion (or slot) no.

### (2) Type 2 Uplink CAP Method

In case a terminal uses a Type 2 CAP for uplink signal (e.g., signal including PUSCH) transmission through an unlicensed band, the terminal may transmit an uplink signal (e.g., signal including PUSCH) through the unlicensed band immediately after sensing that a channel is idle at least during a sensing interval T_{short_ul}=25 μl. T_{short_ul} consists of one slot interval Tₛₗ=9 μs and an immediate following interval T_{f}(=16 μs). T_{f} includes an idle slot interval Tₛₗ at a start point of T_{f}.

### Downlink Channel Structure

A base station transmits a relevant signal to a terminal through a downlink channel described below, and the terminal receives the relevant signal from the base station through the downlink channel described below.

### (1) Physical Downlink Shared Channel (PDSCH)

A PDSCH carries downlink data (e.g., DL-shared channel transport block (DL-SCH TB)) and applies modulation methods such as QPSK (Quadrature Phase Shift Keying), 16 QAM (Quadrature Amplitude Modulation), 64 QAM, and 256 QAM. A codeword is generated by encoding a TB. A PDSCH may carry a maximum of 2 codewords. Scrambling and modulation mapping are performed for each codeword, and modulation symbols generated from each codeword are mapped to one or more layers (layer mapping). Each layer is mapped to a resource together with a demodulation reference signal (DMRS) to be generated as an OFDM symbol signal and is transmitted through a corresponding antenna port.

### (2) Physical Downlink Control Channel (PDCCH)

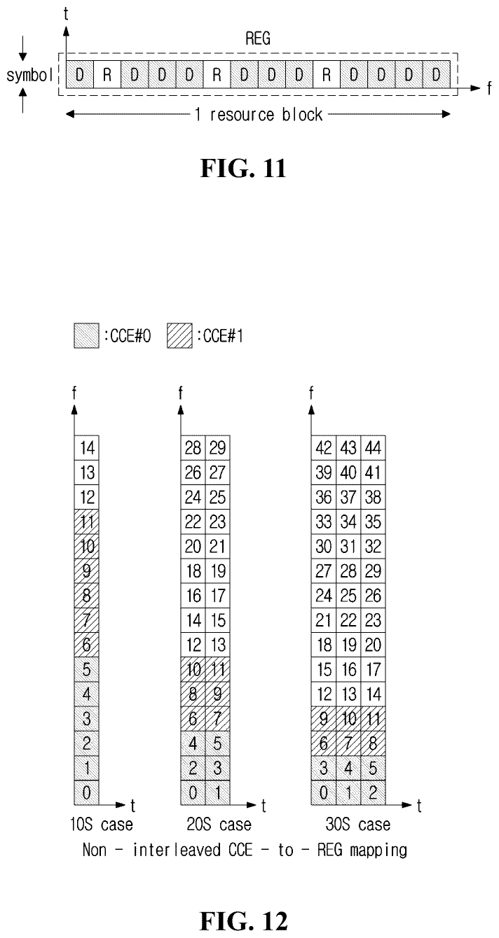

A PDCCH carries downlink control information (DCI) and applies a QPSK modulation method. One PDCCH consists of 1, 2, 4, 8 or 16 control channel elements (CCEs) according to an aggregation level (AL). One CCE consists of 6 resource element groups (REGs). One REG is defined by one OFDM symbol and one (P) RB. FIG. 11 illustrates an example of a single REG structure. In FIG. 11, D represents a resource element to which DCI is mapped, and R represents a RE to which DMRS is mapped. DMRS is a frequency domain direction within one symbol and is mapped to 1st, 5th and 9th REs.

A PDCCH is transmitted through a control resource set (CORESET). A CORESET is defined as a REG set with a given numerology (e.g., SCS, CP length, etc.). A plurality of CORESETs for one terminal may overlap with each other in time/frequency domain. A CORESET may be configured through system information (e.g., MIB) or terminal-specific (UE-specific) higher layer (e.g., radio resource control (RRC)) signaling. Specifically, a number of RBs and a number (up to 3) of symbols constituting a CORESET may be configured by higher layer signaling.

For each CORESET, precoder granularity in frequency domain is configured by higher layer signaling to be one of the following:
sameAsREG-bundle: to be same as a REG-bundle size in frequency domain
allContiguousRBs: to be same as a number of contiguous RBs in frequency domain in CORESET

REGs in a CORESET are numbered based on a time-first mapping manner. That is, REGs are sequentially numbered starting from 0, beginning with a first OFDM symbol in the lowest-numbered resource block in the CORESET.

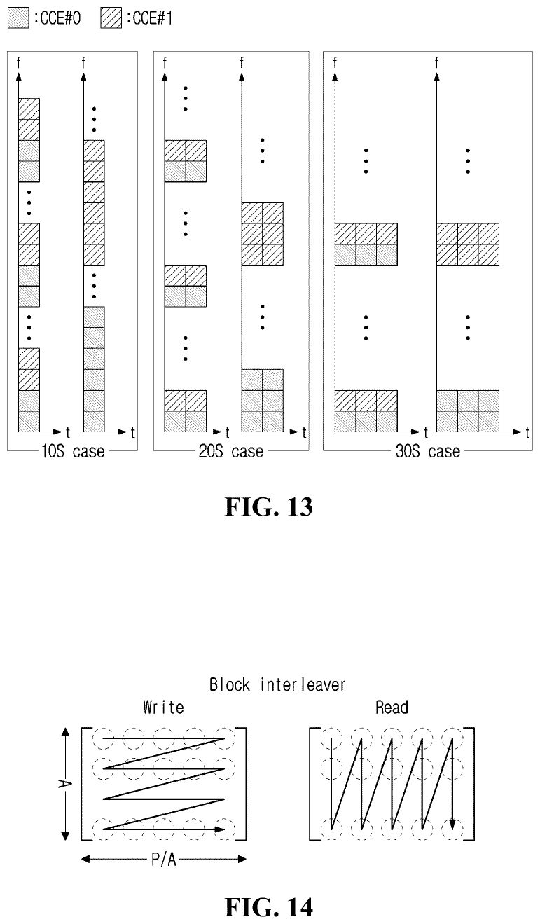

A CCE-to-REG mapping type is configured as one of a non-interleaved CCE-REG mapping type or an interleaved CCE-REG mapping type. FIG. 12 illustrates an example of a non-interleaved CCE-REG mapping type, and FIG. 13 illustrates an example of an interleaved CCE-REG mapping type.
Non-interleaved CCE-REG mapping type (or localized mapping type): 6 REGs for a given CCE constitute one REG bundle, and all REGs for the given CCE are continuous. One REG bundle corresponds to one CCE.
Interleaved CCE-REG mapping type (or distributed mapping type): 2, 3 or 6 REGs for a given CCE constitute one REG bundle, and the REG bundle is interleaved in a CORESET. A REG bundle in a CORESET consisting of 1 OFDM symbol or 2 OFDM symbols consists of 2 or 6 REGs, and a REG bundle in a CORESET consisting of 3 OFDM symbols consists of 3 or 6 REGs. A size of a REG bundle is configured according to each CORESET.

FIG. 14 illustrates an example of a block interleaver. A number (A) of rows of a (block) interleaver for the above interleaving operation is set to one of 2, 3 and 6. In case a number of interleaving units for a given CORESET is P, a number of columns of a block interleaver is equal to P/A. As shown in FIG. 14 below, a writing operation for a block interleaver is performed in a row-first direction, and a reading operation is performed in a column-first direction. A cyclic shift (CS) of an interleaving unit is applied based on an id that is configurable independently of an ID configurable for DMRS.

A terminal performs decoding (namely, blind decoding) for a set of PDCCH candidates to obtain DCI transmitted through a PDCCH. The set of PDCCH candidates decoded by the terminal is defined as a PDCCH search space. A search space set may be a common search space or a UE-specific search space. The terminal may obtain DCI by monitoring PDCCH candidates in one or more search space sets configured by an MIB or higher layer signaling. Each CORESET configuration is associated with one or more search space sets, and each search space set is associated with one CORESET configuration. One search space set is determined based on the following parameters.
controlResourceSetId: indicates a control resource set related to a search space set.
monitoringSlotPeriodicityAndOffset: indicates a PDCCH monitoring periodicity slot (slot unit) and a PDCCH monitoring slot offset (slot unit).
monitoringSymbolsWithinSlot: indicates a PDCCH monitoring pattern within a slot for PDCCH monitoring (e.g., first symbol(s) of a control resource set).
nrofCandidates: indicates a number of PDCCH candidates (one of 0, 1, 2, 3, 4, 5, 6 and 8) for AL={1, 2, 4, 8, 16} respectively.

Table 7 exemplifies a feature according to each search space type.

TABLE 7

| | Search | | |
|---|---|---|---|
| Type | Space | RNTI | Use Case |
| Type0- | Common | SI-RNTI on a primary cell | SIB |
| PDCCH | | | Decoding |
| Type0A- | Common | SI-RNTI on a primary cell | SIB |
| PDCCH | | | Decoding |
| Type1- | Common | RA-RNTI or TC-RNTI on a | Msg2, Msg4 |
| PDCCH | | primary cell | decoding in |
| | | | RACH |
| Type2- | Common | P-RNTI on a primary cell | Paging |
| PDCCH | | | Decoding |
| Type3- | Common | INT-RNTI, SFI-RNTI, TPC- | |
| PDCCH | | PUSCH-RNTI, TPC-PUCCH- | |
| | | RNTI, TPC-SRS-RNTI, C-RNTI, | |
| | | MCS-C-RNTI, or CS-RNTI(s) | |
| | UE | C-RNTI, or MCS-C-RNTI, or | User |
| | Specific | CS-RNTI(s) | specific |
| | | | PDSCH |
| | | | decoding |

Table 8 exemplifies DCI formats that are transmitted through a PDCCH.

TABLE 8

| | |
|---|---|
| 0_0 | Scheduling of PUSCH in one cell |
| 0_1 | Scheduling of one or multiple PUSCH in one cell, or indicating |
| | downlink feedback information for configured grant PUSCH (CG- |
| | DFI) |
| 1_0 | Scheduling of PDSCH in one cell |
| 1_1 | Scheduling of PDSCH in one cell, and/or triggering one shot |
| | HARQ-ACK codebook feedback |
| 2_0 | Notifying a group of UEs of the slot format, available RB sets, |
| | COT duration and search space set group switching |
| 2_1 | Notifying a group of UEs of the PRB(s) and OFDM symbol(s) |
| | where UE may assume no transmission is intended for the UE |
| 2_2 | Transmission of TPC commands for PUCCH and PUSCH |
| 2_3 | Transmission of a group of TPC commands for SRS transmissions |
| | by one or more UEs |

DCI format 0_0 may be used to schedule a TB-based (or TB-level) PUSCH, and DCI format 0_1 may be used to schedule a TB-based (or TB-level) PUSCH or a code block group (CBG)-based (or CBG-level) PUSCH. DCI format 1_0 may be used to schedule a TB-based (or TB-level) PDSCH, and DCI format 1_1 may be used to schedule a TB-based (or TB-level) PDSCH or a CBG-based (or CBG-level) PDSCH (DL grant DCI). DCI format 0_0/0_1 may be referred to as UL grant DCI or UL scheduling information, and DCI format 1_0/1_1 may be referred to as DL grant DCI or UL scheduling information. DCI format 2_0 is used to deliver dynamic slot format information (e.g., dynamic SFI) to a terminal, and DCI format 2_1 is used to deliver downlink pre-Emption information to a terminal. DCI format 2_0 and/or DCI format 2_1 may be delivered to terminals within a single group through a group common PDCCH that is a PDCCH delivered to terminals defined as the group.

### Uplink Channel Structure

A terminal transmits a relevant signal to a base station through an uplink channel described below, and the base station receives the relevant signal from the terminal through the uplink channel described below.

### (1) Physical Uplink Shared Channel (PUSCH)

A PUSCH carries uplink data (e.g., UL-shared channel transport block (UL-SCH TB) and/or uplink control information (UCI) and is transmitted based on a cyclic prefix-orthogonal frequency division multiplexing (CP-OFDM) waveform or a discrete Fourier transform-spread-orthogonal frequency division multiplexing (DFT-s-OFDM) waveform. In case the PUSCH is transmitted based on the DFT-s-OFDM waveform, a terminal transmits the PUSCH by applying transform precoding. As an example, if transform precoding is impossible (e.g., transform precoding is disabled), the terminal may transmit the PUSCH based on the CP-OFDM waveform, and if transform precoding is possible (e.g., transform precoding is enabled), the terminal may transform the PUSCH based on the CP-OFDM waveform or the DFT-s-OFDM waveform. PUSCH transmission may be dynamically scheduled by an UL grant within DCI or semi-statically scheduled (configured grant) based on higher layer (e.g., RRC) signaling (and/or Layer 1 (L1) signaling (e.g., PDCCH)). PUSCH transmission may be performed based on a codebook or based on non-codebook.

### (2) Physical Uplink Control Channel (PUCCH)

PUCCHs carry uplink control information, HARQ-ACK and/or a scheduling request (SR) and are classified into short PUCCHs and long PUCCHs according to PUCCH transmission lengths. Table 9 exemplifies PUCCH formats.

TABLE 9

| | Length in | | | |
|---|---|---|---|---|
| | OFDM | | | |
| PUCCH | symbols | Number | | |
| format | N_{symb}^{PUCCH} | of bits | Usage | Etc |
| 0 | 1-2 | ≤2 | HARQ, SR | Sequence selection |
| 1 | 4-14 | ≤2 | HARQ, [SR] | Sequence modulation |
| 2 | 1-2 | >2 | HARQ, CSI, | CP-OFDM |
| | | | [SR] | |
| 3 | 4-14 | >2 | HARQ, CSI, | DFT-s-OFDM |
| | | | [SR] | (no UE multiplexing) |
| 4 | 4-14 | >2 | HARQ, CSI, | DFT-s-OFDM |
| | | | [SR] | (Pre DFT OCC) |

PUCCH format 0 carries UCI with a maximum size of 2 bits and is transmitted by being mapped based on a sequence. Specifically, a terminal transmits specific UCI to a base station by transmitting one sequence of a plurality of sequences through a PUCCH that is PUCCH format 0. Only when transmitting a positive SR, the terminal transmits a PUCCH, which is PUCCH format 0, within a PUCCH resource for a corresponding SR configuration.

PUCCH format 1 carries UCI with a maximum size of 2 bits, and a modulation symbol is spread by an orthogonal cover code (OCC) (which is differently configured according to whether frequency hoping occurs) in time domain. A DMRS is transmitted in a symbol where the modulation symbol is not transmitted (that is, it is transmitted by being time-division multiplexed (TDM)).

PUCCH format 2 carries UCI with a bit size greater than 2 bits, and a modulation symbol is transmitted by being frequency division multiplexed (FDM) with a DMRS. A DM-RS is located with a density of ⅓ in symbol indexes #1, #4, #7 and 10 within a given resource block. A pseudo noise (PN) sequence is used for a DM_RS sequence. Frequency hopping may be activated for 2-symbols PUCCH format 2.

PUCCH format 3 does not enable terminal multiplexing within same physical resource blocks and carries UCI with a bit size greater than 2 bits. In other words, a PUCCH resource of PUCCH format 3 does not include any orthogonal cover code. A modulation symbol is transmitted by being time division multiplexed with a DMRS.

### Network Access and Communication Process

A terminal may perform a network access process. For example, while performing access to a network (e.g., base station), the terminal may receive system information and configuration information, which are necessary to perform a procedure and/or methods described/proposed below, and store the information in a memory. Configuration information necessary for the present disclosure may be received through higher layer (e.g., RRC layer, medium access control (MAC) layer, etc.) signaling.

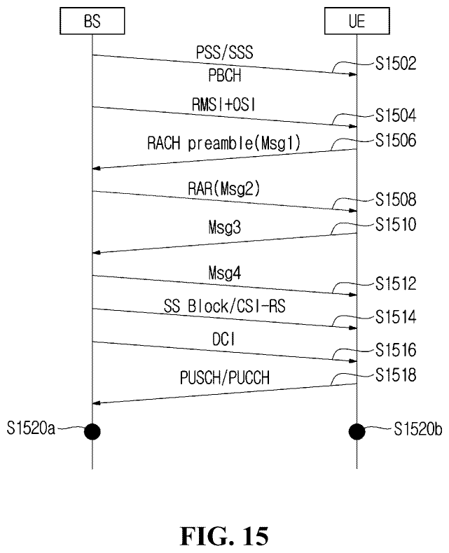

FIG. 15 illustrates an example of a network initial access and communication procedure that is applicable to the present disclosure. In NR, a physical channel and a reference signal may be transmitted by using beamforming. In case beamforming-based signal transmission is supported, there may be a beam management process for aligning a beam between a base station and a terminal. In addition, a signal proposed in the present disclosure may be transmitted/received by using beamforming. In a radio resource control (RRC) IDLE mode, beam alignment may be performed based on an SSB. On the other hand, in a RRC-CONNECTED mode, beam alignment may be performed based on CSI-RS (in DL) and SRS (in UL). Meanwhile, in case beamforming-based signal transmission is not supported, a beam-related operation may be skipped in the description below.

Referring to FIG. 15, a base station (e.g., BS) may periodically transmit an SSB (S1502). Herein, the SSB includes PSS/SSS/PBCH. The SSB may be transmitted by using beam sweeping (refer to FIG. 14). Next, the base station may transmit remaining minimum system information (RMSI) and other system information (OSI) (S1504). RMSI may include information that is necessary for the terminal to have an initial access to the base station (e.g., PRACH configuration information). Meanwhile, after performing SSB detection, the terminal identifies a best SSB. Next, the terminal may transmit a RACH preamble (message 1 (Msg1)) to the base station by using a PRACH resource linked/corresponding to an index (that is, beam) of the best SSB (S1506). A beam direction of the RACH preamble is associated with the PRACH resource. Association between the PRACH resource (and/or the RACH preamble) and the SSB (index) may be configured through system information (e.g., RMSI). Next, as a part of a RACH process, the base station may transmit a random access response (Msg2) as a response to the RACH preamble (S1508), and the terminal may transmit Msg3 (e.g., RRC connection request) by using a UL grant in the RAR (S1510), and the base station may transmit a contention resolution message (Msg4) (S1512). Msg4 may include a RRC connection setup.

When a RRC connection between the base station and the terminal is configured through the RACH process, subsequent beam alignment may be performed based on an SSB/CSI-RS (in DL) and an SRS (in UL). For example, the terminal may receive the SSB/CSI-RS (S1514). The SSB/CSI-RS may be used for the terminal to generate a beam/CSI report. Meanwhile, the base station may request the beam/CSI report to the terminal through DCI (S1516). In this case, the terminal may generate the beam/CSI report based on the SSB/CSI-RS and transmit the generated beam/CSI report to the base station through a PUSCH/PUCCH (S1518). The beam/CSI report may include a beam measurement result, information on a preferred beam, and the like. The base station and the terminal may switch beams based on the beam/CSI report (S1520a and S1520b).

Next, the terminal and the base station may perform a procedure and/or methods described below. For example, based on configuration information obtained from a network access process (e.g., a system information acquisition process, a RRC connection process through RACH, etc.), the terminal and the base station may process information, which is present in a memory as proposed by the present disclosure, and transmit a radio signal or process and store a received radio signal. Herein, the radio signal may include at least one of a PDCCH, a PDSCH and a reference signal (RS) in downlink and at least one of a PUCCH, a PUSCH and an SRS in downlink.

### Specific Embodiment of the Present Disclosure

The present disclosure relates to full-duplex (FD)-based communication in an unlicensed band in a wireless communication system, and particularly, to a technology for performing a CAP operation during signal transmission using full-duplex communication. The present disclosure will describe various embodiments about a signal transmission and a CAP operation of a base station. However, the embodiments described below will also be applied to a signal transmission and a CAP operation of a terminal in a same manner or after being a little modified. In the present disclosure, an unlicensed band means a frequency band that is non-exclusively used, and may also be referred to as another term like a shared spectrum or any other terms with an equivalent technical meaning. In addition, access to an unlicensed band may be referred to as shared spectrum channel access.

### FD Operation for NR

In 5G, new service types are emerging such as extended reality (XR), AI-based services and self-driving cars, and such services have dynamic changes of traffic in both DL and UL directions and require low latency in packet transmission. Traffic loads in 5G services will explode while supporting such new diverse use cases.

On the other hand, an existing semi-static or dynamic TDD UL/DL configuration is constrained by transmission time latency and interference between operators. An existing FDD scheme has a limitation in efficient use of frequency resources in DL/UL directions. Accordingly, introduction of a full duplex (FD) operation in a single carrier is under discussion to lower latency time and efficiently use resources in NR.

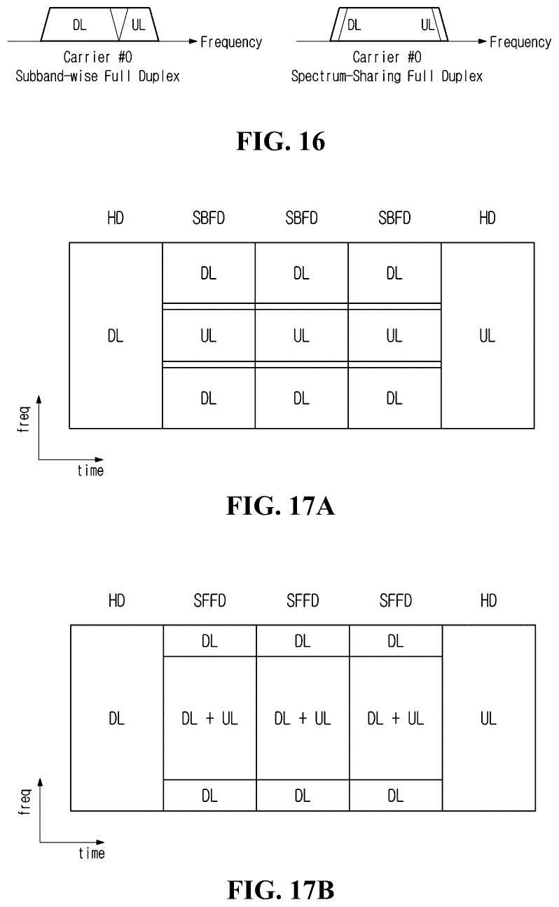

For an example of applying intra-carrier FD, subband-wise full-duplex (SB-FD) and spectrum-sharing full-duplex (SS-FD) may be considered as shown in FIG. 16. FIG. 16 illustrates an example of full-duplex communication between carriers that is applicable to the present disclosure. In SB-FD, transmissions of DL and UL are performed in different frequency resources within a same carrier. That is, for a same time resource, DL and UL occupy different frequency resources. In SS-FD, transmissions of DL and UL are performed in a same frequency resource or overlapped frequency resources within a same carrier. That is, for a same time resource, DL and UL may occupy a same frequency resource or overlapped frequency resources.

Such FD operation may be used in combination with an existing half-duplex (HD) operation. For example, in an HD-based TDD operation, only some time resources may be used to an FD operation. In a time resource for performing the FD operation, an SB-FD or SS-FD operation may be performed.

FIG. 17A and FIG. 17B illustrate an example of coexistence of a time resource with half-duplex (HD) operation and a time resource with FD operation, which is applicable to the present disclosure. In FIG. 17A, some time resources are operated as SB-FD, and the remaining time resources are operated as HD. In FIG. 17B, some time resources are operated as SS-FD, and the remaining time resources are operated as HD. Herein, for example, a unit of a time resource may be a slot or a symbol.

In a time resource operated as SB-FD, some frequency resources are used as DL resource, and some frequency resources are used as UL resource. Between DL and UL frequency resources, there may be a guard band, a guard frequency resource or a guard subcarrier that is used as neither DL nor UL but is emptied. In a time resource operated as SS-FD all frequency resources may be used both for DL and for UL. Alternatively, in order to reduce an impact of interference from another adjacent carrier (e.g., adjacent carrier interference (ACI)), some frequence resources at one end or both ends of a carrier may not be used for DL and/or UL. That is, the one end or both ends of a carrier may be used as a guard band that is used neither for DL and for UL. Alternatively, in order to reduce ACI affecting UL reception, one end or both ends of a carrier may be used only for DL transmission.

In the present disclosure, a slot resource operated as HD is referred to as HD-slot, and a slot resource operated as SB-FD and a slot resource operated as SS-FD are referred to as SB-FD slot and SS-FD slot respectively. In addition, the SB-FD slot and the SS-FD slot may be collectively referred to as FD slot. In the present disclosure, of all frequency resources in a time resource operated as FD, a frequency resource for a DL operation is referred to as DL sub-band, and a frequency resource for a UL operation is referred to as UL sub-band. As shown in FIG. 17A and FIG. 17B, frequency resources operating as DL and UL are referred to as XL sub-band.

In the case of the above-described FD operation, both a gNB and/or a terminal may perform the FD operation. That is, both the gNB and the terminal may perform a DL and UL operation simultaneously by using a same frequency resource or different frequency resources in a same time resource. As another example, the gNB alone may perform the FD operation, and the terminal may perform HD. The gNB may perform DL transmission and UL reception simultaneously by using a same frequency resource or different frequency resources in a same time resource, but the terminal may perform only DL reception or UL transmission in a specific time resource. In this case, the gNB may perform the FD operation by performing DL transmission and UL reception with different terminals at a same time.

The description below shows an example in which a gNB performs an FD operation, while a terminal performs an HD operation. However, various embodiments of the present disclosure may be applied to a case in which both a gNB and a terminal perform an FD operation, or a case in which a gNB performs an HD operation and a terminal performs an FD operation.

As more and more communication devices require a larger communication capacity, efficient utilization of a limited frequency band becomes a more important requirement for a future wireless communication system. Cellular communication systems like LTE/NR system are also considering a traffic offloading method using the unlicensed band of 2.4 GHz, which is mainly used for the existing WiFi system or newly highlighted unlicensed bands like 5/6 GHz and 60 GHz.

Basically, as an unlicensed band assumes that wireless transmission and reception are performed through contention between each communication node, it requires that each communication node performs channel sensing before transmitting a signal and signal transmission is not performed by any other communication nodes. Such a post-sensing transmission operation is referred to as LBT (listen before talk) or CAP (channel access procedure), and in particular, an operation of checking whether another communication node performs signal transmission is referred to as carrier sensing (CS), and when it is determined that another communication node does not perform signal transmission, clear channel assessment (CCA) has been identified. In the description below, LBT may be replaced by CAP.

An eNB/gNB or UE of an LTE/NR system should perform LBT to transmit a signal in an unlicensed band (hereinafter, referred to as ‘U-band’). When the eNB/gNB or UE of the LTE/NR system transmits a signal, other communication nodes like wireless gigabit alliance (WiGig) of Wi-Fi or 802.11ad/ay should perform LBT to prevent interference. For example, a Wi-Fi standard (e.g., 802.11ac) specifies −62 dBm and −82 dBm as a CCA threshold for a non-Wi-Fi signal and a Wi-Fi signal respectively. According to these limits, an STA or AP does not transmit a signal not to cause interference, for example, when a non-Wi-Fi signal is received at a power above-62 dBm.

The present disclosure proposes a CAP of a base station and/or a terminal capable of operating in FD mode in an unlicensed band. While a base station/terminal capable of operating in FD mode is performing transmission in a specific band, the base station/terminal may perform a CAP through reception in a band adjacent to the specific band and begin transmission after succeeding in the CAP, and thus a radio resource may be efficiently used.

In the NR standard, a basic unit for performing a CAP may correspond to an approximate 20 MHz bandwidth, and the 20 MHz bandwidth is defined as channel in TS 37.213 or as RB set in TS 38.214. The present disclosure may describe the channel or RB set as LBT BW, both of which may be understood as have a same meaning.

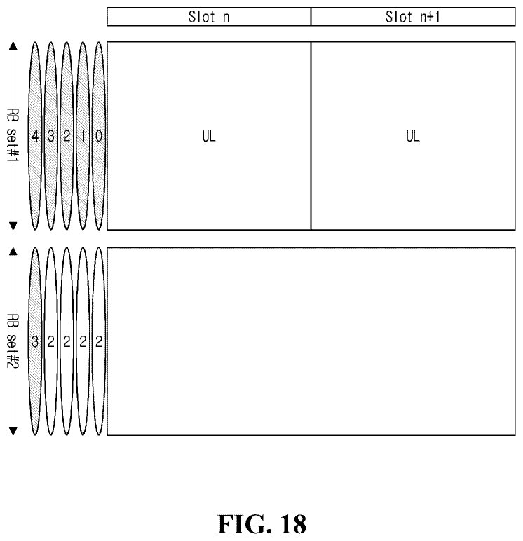

FIG. 18 illustrates an example of a CAP operation for communication in an unlicensed band that is applicable to the present disclosure. In case of a CAP operation of a base station incapable of an FD operation, as exemplified in FIG. 18, when a multi-channel CAP is performed for a RB set #1 and a RB set #2, if the CAP is successful only for the RB set #1 (e.g., if a backoff counter value becomes 0 immediately before a slot n transmission) and the CAP fails in the RB set #2 (e.g., if the backoff counter value does not reach 0 because a channel is busy immediately before the slot n transmission), the base station may perform DL transmission in the RB set #1.

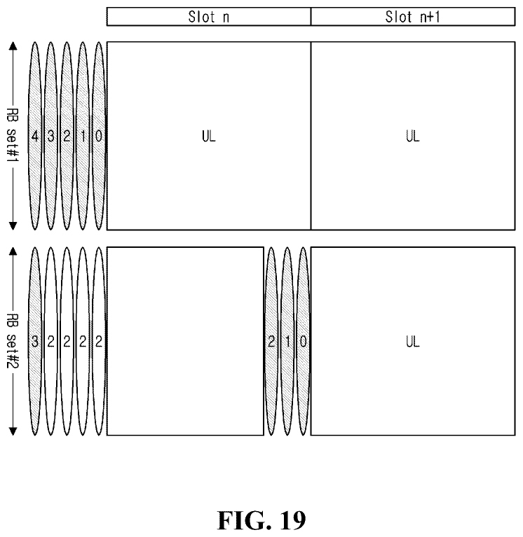

On the other hand, a CAP operation of a base station capable of an FD operation is as follows. FIG. 19 illustrates another example of a CAP operation for communication in an unlicensed band that is applicable to the present disclosure. As exemplified in FIG. 19, a base station may keep performing a CAP through signal reception in the RB set #2, while transmitting a signal in the RB set #1. Specifically, if a backoff counter value corresponding to the RB set #2 immediately before slot n transmission is 2, the base station may perform a CAP for the RB set #2 at the same time as transmission in the RB set #1 in a slot n. In addition, if the back off counter value corresponding to the RB set #2 immediately before slot n+1 transmission reaches 0 because the channel is idle, the base station may also start signal transmission in the RB set #2.

The present disclosure proposes various embodiments related to a relationship between a RB set and a sub-band of SB-FD or SS-FD (e.g., DL/UL/XL sub-band), a method of determining an energy detection (ED) threshold, a method of determining COT starting/ending, and a multi-channel CAP method.

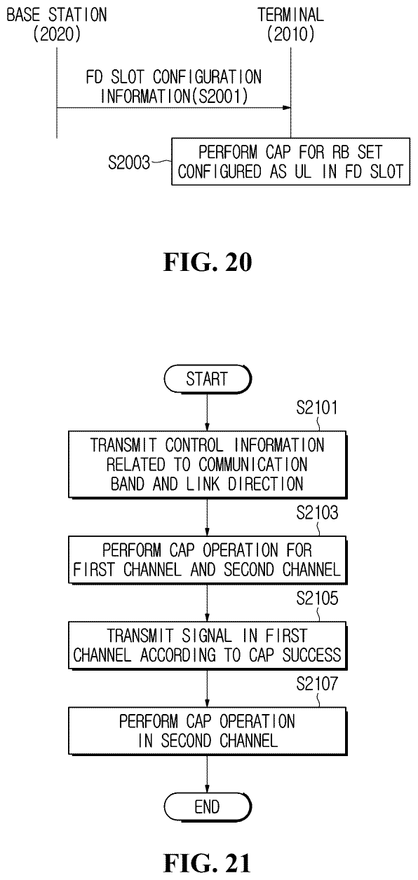

FIG. 20 illustrates an example of a procedure of applying an FD operation to an unlicensed band in a wireless communication system according to an embodiment of the present disclosure. FIG. 20 exemplifies signal exchange between a terminal 2010 and a base station 2020. The base station 2020 of FIG. 20 has FD-capability and may configure at least one slot for an FD operation on the terminal 2010 through a procedure as shown in FIG. 20.

Referring to FIG. 20, at step S2001, the base station 2020 transmits FD slot configuration information to the terminal 2010. The FD slot configuration information may indicate at least one of a time of a slot supporting an SB-FD operation, a frequency axis location and size, and a link direction (e.g., DL, UL, DL+UL). According to an embodiment, for RB sets belonging to one BWP, the base station 2020 may configure DL/UL of each RB set by using the configuration information. Specifically, the base station 2020 may configure/indicate link information like DL, UL or DL+UL for each RB set.

At step S2003, the terminal 2010 performs a CAP for a RB set configured as UL or DL+UL. Although not illustrated in FIG. 20, when the CAP is completed, the terminal 2010 may perform UL transmission through a corresponding RB set. FIG. 20 shows only the CAP operation of the terminal 2010, but according to another embodiment, the base station 2020 may also perform a CAP operation for DL transmission.

FIG. 21 illustrates an example of a procedure of transmitting a signal by using an unlicensed band in a wireless communication system according to an embodiment of the present disclosure. FIG. 21 exemplifies a method for operating a base station.

Referring to FIG. 21, at step S2101, a bast station transmits control information related to a communication band and a link direction. Herein, the control information includes at least one of system information, configuration information of a higher layer, and control information of a physical layer. Specifically, the base station may transmit system information including information related to a communication band, transmit configuration information related to distinguishing a UL resource and a DL resource within the communication band, or transmit information indicating a link direction(s) applied within a specific time interval (e.g., slot). For example, control information may include information related to a link direction for channels belonging to an unlicensed band. In this case, according to an embodiment, the control information may indicate the information related to the link direction according to each channel or each channel group, and for example, whether an FD operation is allowed may be indicated according to each channel or each channel group. Herein, a channel is a unit of frequency axis where a CAP operation or an LBT operation is performed, and may also be referred to as RB set.

At step S2103, the base station performs a CAP operation for a first channel and a second channel. For example, the base station may perform the CAP operation based on the control information received at step S2101. The control information includes information on a link direction of a plurality of channels including the first channel and the second channel and indicates a link direction of each of the first channel and the second channel as DL or DL+UL. Accordingly, the base station determines the first channel and the second channel as candidate channels for performing DL transmission and performs the CAP operation. Herein, as the first channel and the second channel are unit resources for different CAP operations, the base station performs a CAP operation independently in each of the first channel and the second channel. In other words, the base station may determine a backoff counter value for the first channel and the second channel and determine availability of a channel (e.g., whether it is busy/idle).

At step S2105, the base station transmits a signal in the first channel according to CAP success. In other words, the base station performs the CAP operation for the first channel and determines the CAP success when determining that the channel is idle. Accordingly, the base station may occupy the first channel during a predetermined time interval and transmit a signal. Herein, in an embodiment of FIG. 21, a CAP for the second channel fails. That is, the base station determines CAP success only for the first channel and determines that the second channel is busy by being occupied by another device. Thus, the base station does not perform DL transmission in the second channel.

At step S2107, the base station performs a CAP operation in the second channel. In other words, while transmitting the signal in the first channel, the base station may receive a signal in the second channel and keep performing the CAP operation by using the received signal. As the base station supports the FD operation and a band including the first channel and the second channel is configured to allow the FD operation, the base station may transmit a signal in the first channel and receive a signal in the second channel.

[Embodiment #1] In a certain FD slot, a DL or UL or XL sub-band may be determined based on RB set unit granularity. That is, a DL or UL or XL sub-band in a certain FD slot may be configured as a single RB set or a plurality of RB sets.

For a certain slot or all or some OFDDM symbols within the slot, a base station may notify whether a link direction applied to a portion of a frequency resource belonging to a bandwidth of a carrier/BWP is DL or UL or DL+UL (e.g., SS-FD) through higher layer signaling (e.g., cell-specific or group-common or UE-specific RRC signaling) and/or L1 signaling (e.g., UE-specific DCI or UE group-common DCI). Herein, a minimum unit of a resource indicated by corresponding signaling may be a RB set, and a region of DL or UL or DL+UL belonging to a bandwidth may be signaled in a RB set. For example, for a BWP consisting of 4 RB sets, RB set #1 and RB set #2 may be signaled as DL sub-bands, and RB set #3 and RB set #4 may be signaled as UL sub-bands.

According to the above-described embodiments, control information related to a communication band and a link direction may be transmitted, and communication in an unlicensed band may be performed based on the control information. Herein, the control information may be understood as being directed to configuring an FD slot. The FD slot may include at least one sub-band. Herein, according to various embodiments, for a sub-band within the FD slot, a length value in a RB set unit, that is, how many RB set(s) are included may be set as a bandwidth. For example, if a size of a sub-band within the FD slot is indicated to be k, this indicates that the sub-band includes k RB sets. Alternatively, a sub-band within the FD slot may be configured by using a bitmap for RB sets. Each bit in the bitmap corresponds to one RB set, and a RB set corresponding to bits set to a positive value (e.g., 1) in the bitmap represents RB set(s) in a corresponding sub-band. Alternatively, a constraints may be added to the effect that only continuous RB sets of k RB sets may be configured as a UL and/or DL sub-band. In consideration of this, among k RB sets, one start RB set index and the number of RB sets beginning with a start RB set may be set/indicated. Specifically, a corresponding combination (of a start RB set index and the number of RB sets) may be indexed, and one of indexes may be set/indicated in a similar way to a resource indication value (RIV) method of frequency domain resource allocation (FDRA) type 1.

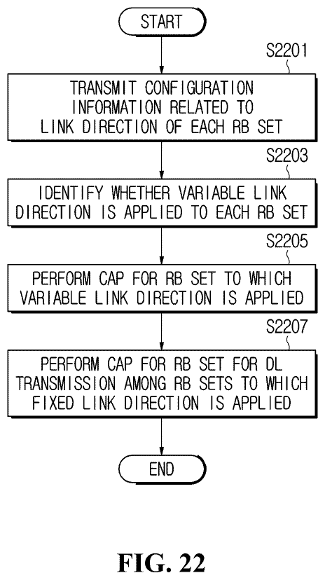

According to an embodiment, DL or UL or DL+UL of each RB set may be determined according to a CAP result of a base station and/or a terminal. For example, for a BWP including 4 RB sets, when the base station succeeds in a CAP and occupies a channel of RB set #1 and RB set #2, RB set #1 and RB set #2 may be a DL sub-band. In addition, when the terminal succeeds in a CAP and occupies a channel of RB set #3 and RB set #4, RB set #3 and RB set #4 may be a UL sub-band. According to a CAP result of each RB set, each RB set group or each BWP/carrier, whether DL or UL or DL+UL can be determined may be separately signaled. For example, for a specific RB set in which an indication is signaled to the effect “DL or UL or DL+UL may be determined according to a CAP result”, DL or UL or DL+UL of the RB set may be different depending on whether a node succeeding in a CAP is a base station and/or a terminal. On the other hand, for a specific RB set in which an indication is signaled to the effect “DL or UL or DL+UL may not be determined according to a CAP result”, DL or UL or DL+UL of the RB set may be determined/defined/configured/indicated in advance, and a terminal (e.g., in the case of UL or DL+UL) or a base station (e.g., in the case of DL or DL+UL) may occupy a channel after a CAP accordingly. Thus, determination of a link direction for each RB set may be performed as shown in FIG. 22 below.

FIG. 22 illustrates an example of a procedure of determining a link direction of a channel in an unlicensed band in a wireless communication system according to an embodiment of the present disclosure. FIG. 22 exemplifies a method for operating a base station.

Referring to FIG. 22, at step S2201, a base station transmits configuration information related to a link direction of each RB set. The configuration information related to a link direction of each RB set may be transmitted as a portion of configuration information related to an FD slot or as separate control information. According to various embodiments, the configuration information related to a link direction of each RB set may indicate whether a link direction applied to each RB set is dependent on a CAP result, in other words, whether the link direction is variable according to a CAP result. For example, the configuration information related to a link direction of each RB set may indicate whether the link direction may be determined as DL or UL or DL+UL according to a CAP result.

At step S2203, the base station identifies whether a variable link direction is applied to each RB set. Based on the configuration information received at step S2201, the base station may identify whether the variable link direction is applied to each RB set. However, according to other embodiments, whether the variable link direction is applied may be indicated and identified not only in a RB set unit but also in a RB set group unit or a BWP unit.

At step S2205, the base station performs a CAP for a RB set to which a variable link direction is applied. That is, if a variable link direction is applied, a link direction applied to a corresponding RB set is not fixed, and thus the base station may perform a CAP for the RB set. In addition, although not illustrated in FIG. 22, when successfully occupying a channel through the CAP, the base station may perform DL transmission in the RB set.

At step S2207, the base station performs a CAP for a RB set for DL transmission among RB sets to which a fixed link direction is applied. Herein, the RB set for DL transmission includes a RB set for which a link direction is set to DL or DL+UL. In the case of a RB set for UL transmission, DL transmission is not allowed, and thus the base station need not perform a CAP for the RB set and performs a CAP for remaining RB set(s). In addition, although not illustrated in FIG. 22, when successfully occupying a channel through the CAP, the base station may perform DL transmission in a RB set for the DL transmission.

As shown in Table 10 below, an intra-cell guard band may be configured between adjacent RB sets. A size of an intra-cell guard band is expressed by the number of RBs, and a value expressing the number of RBs equal to or greater than 0 may be set as the size of the intra-cell guard band. In order to support an SB-FD or SS-FD operation in an FD slot, a guard band for adjusting an amount of self-interference may be needed between adjacent sub-bands. Herein, only when an intra-cell guard band greater than a predetermined size (e.g., X RB(s)) is configured, an SB-FD or SS-FD operation may be allowed for a corresponding BWP/carrier. X may be defined in advance (e.g., X=0), or a default value of X may be predefined in specifications, and the value of X may also be set by higher layer signaling. In other words, for a BWP/carrier in which the number of RBs equal to or less than X is set as an intra-cell guard band, a specific slot may be constrained to operate only as an HD slot. Table 10 below is an excerpt from TS 38.214 V17.2.0, describing a procedure related to an intra-cell guard band.

TABLE 10
7 UE procedures for transmitting and receiving on a carrier with intra-cell guard
bands
For operation with shared spectrum channel access for FRI, when the UE is
configured with any of IntraCellGuardBandsPerSCS for UL carrier and for DL
carrier with SCS configuration μ, the UE is provided with N_{RB-set,x} − 1 intra-cell
guard bands on a carrier with μ, each defined by start CRB and size in number
$of CRBs , {GB}_{s , x}^{start , μ} and {GB}_{s , x}^{size , μ} , provided by higher layer parameters startCRB$
and nrofCRBs, respectively, where s ∈ {0, 1, ... , N_{RB-set,x} − 2}. The subscript x is
set to DL and UL for the downlink and uplink, respectively. Where there is no
risk of confusion, the subscript x can be dropped. The intra-cell guard bands
$separate {N}_{RB - set , x} RB sets , each defined by start and end CRB , {RB}_{s , x}^{start , μ} and$
${RB}_{s , x}^{emd , μ} , respectively . The UE does not expect that nrofCRBs is configured with$
non-zero value smaller than the applicable intra-cell guard bands as specified in
$[ 8 , TS 38.101 - 1 ] corresponding to μ and carrier size {N}_{grid , x}^{size , μ} . The UE determines$
the start and end CRB indices for s E {0,1, ... , N_{RB-set,x} − 1} as
${RB}_{s , x}^{start , μ} = {N}_{grid , x}^{start , μ} + \{ \begin{matrix}0 & s = 0 \\ {GB}_{s - 1 , x}^{start , μ} + {GB}_{s - 1 , x}^{size , μ} & otherwise\end{matrix}$
and
${RB}_{s , x}^{end , μ} = {N}_{grid , x}^{start , μ} + \{ \begin{matrix}{N}_{grid , x}^{start , μ} - 1 & s = {N}_{RB - set , x} - 1 \\ {GB}_{s , x}^{start , μ} - 1 & otherwise\end{matrix}$
$The RB set with index s consists of {RB}_{s , x}^{size , μ} resource blocks where {RB}_{s , x}^{size , μ} =$
${RB}_{s , x}^{end , μ} - {RB}_{s , x}^{start , μ} + 1. When the UE is not configured with IntraCellGuardBands$
PerSCS for μ, the UE determines the CRB indices for the intra-cell guard band
(s), if any, and corresponding RB set(s) according to the nominal intra-cell guard
band and RB set pattern as specified in [8, TS 38.101-1] corresponding to μ and
$carrier size {N}_{grid , x}^{size , μ} . For either or both DL and UL , if the nominal intra - cell$
guard band and RB set pattern as specified in [8, TS 38.101-1] contains no intra-
cell guard bands, the number of RB sets for the carrier is N_{RB-set,x} = 1.
$For a carrier with μ , the UE expects {N}_{BWP , i}^{start , μ} = {RB}_{s 0 , x}^{start , μ} and {N}_{BWP , i}^{size , μ} =$
${RB}_{s 1 , x}^{end , μ} - {RB}_{s 0 , x}^{start , μ} + 1 where 0 \leq s 0 \leq s 1 \leq {N}_{RB - set , x} - 1 for a BWP i configured$
by initialDownlinkBWP or BWP-Downlink for the DL BWP, or initialUplink
BWP or BWP-Uplink for the UL BWP. Within the BWP i, RB sets are numbered
$in increasing order from 0 to {N}_{RB - set , x}^{BWP} - 1$
$where {N}_{RB - set , x}^{BWP} is the number of RB sets contained in the BWP i$
and RB set 0 within the BWP i corresponds to RB set s0 in the carrier and RB set
${N}_{RB - set , x}^{BWP} - 1 within the BWP i corresponds to RB set s 1 in the carrier .$
When a UE is provided with nrofCRBs = 0 for all intra-cell guard band(s) on a
carrier with μ, the UE is indicated that no intra-cell guard-bands are configured
for the carrier and expects N_{RB-set,x} > 1. For μ = 0, the UE expects the number
of RBs within a RB set is between 100 and 110. For μ = 1, the UE expects the
number of RBs within a RB set is between 50 and 55 except for at most one
RB set which may contain 56 RBs.

[Embodiment #2] If an ED threshold or its maximum value applied before a base station succeeds in a CAP is expressed by TH #1 and while transmission is performed after a CAP is successful for a channel #1, an ED threshold or its maximum value applied during a CAP of another channel #2 is expressed by TH #2, a value of TH #2 may be defined as a relaxed value, that is, a higher value than a value of TH #1 in consideration of self-interference from the channel #1 in which transmission is already underway.

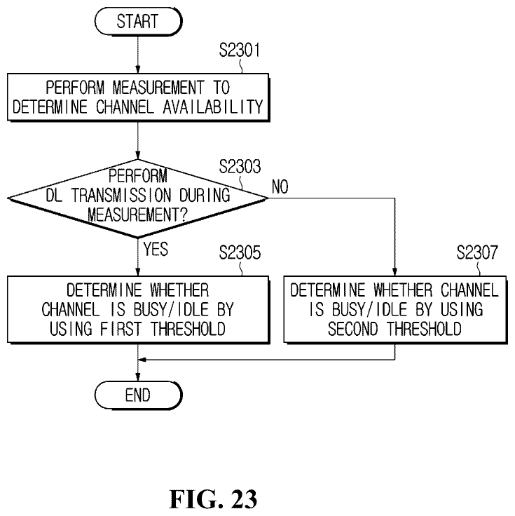

For example, in a situation as shown in FIG. 19 above, when an ED threshold or its maximum size, which a base station applies when performing a CAP for RB set #1 and RB set #2 before transmission of a slot n, is referred to as TH #1 and an ED threshold or its maximum size, which the base station applies when performing a CAP for RB set #2 before transmission of a slot n+1, is referred to as TH #2, a value of TH #2 may be greater than a value of TH #1. This is because energy received and/or measured in RB set #2 may increase under the influence of interference leakage or self-interference of a DL signal that is transmitted at slot n. For example, when a value of {TH #2-TH #1} is defined as Y (>0 or ≥0), the size of Y may be predefined. A corresponding link direction according to each RB set may be determined as shown in FIG. 23 below.

FIG. 23 illustrates an example of a procedure of determining availability of a channel in an unlicensed band in a wireless communication system according to an embodiment of the present disclosure. FIG. 23 exemplifies a method for operating a base station.

Referring to FIG. 23, at step S2301, a base station performs measurement to determine channel availability. Specifically, the base station sets a backoff counter value and measures an energy value of a signal received from the outside of a corresponding RB set to determine whether to reduce the backoff counter value.

At step S2303, the base station checks whether DL transmission is performed during the measurement. In other words, the base station checks whether the measurement of step S2301 is performed by using an FD operation, specifically, whether a signal is received from the outside while DL transmission is performed.

If the DL transmission is performed during the measurement, at step S2305, the base station determines whether a channel is busy/idle by using a first threshold. In other words, when determining whether the channel is occupied by another device based on an energy value that is a result of the measurement of step S2301, the base station uses the first threshold (e.g., TH #1) as a threshold compared with the measured energy value. Herein, in consideration of the impact of DL transmission, the first threshold may be defined as a greater value than a second threshold used below.

If DL transmission is not performed during the measurement, at step S2307, the base station determines whether the channel is busy/idle by using the second threshold. In other words, when determining whether the channel is occupied by another device based on an energy value that is a result of the measurement of step S2301, the base station uses the second threshold (e.g., TH #2) as the threshold compared with the measured energy value.

Herein, a value of Y, which is a difference between the first threshold and the second threshold, may be differently set according to how adjacent RB set #1 and RB set #2 are to each other or a transmission power value of the base station. For example, because the impact of interference may be smaller with a greater spacing between RB sets, a greater value of Y may be applied with a smaller spacing between RB set #1 and RB set #2, and a smaller value of Y may be applied with a greater spacing therebetween. As another example, because an amount of interference affecting a neighbor frequency axis resource may increase along with an increase of power value of the base station, a greater Y value may be applied with a greater power value, and a smaller Y value may be applied with a smaller power value.

[Embodiment #3] In case a base station capable of FD transmission performs a multi-channel CAP, a specific CAP may be different according to which type of CAP (e.g., Type A1, A2, B1 or B2) is performed.

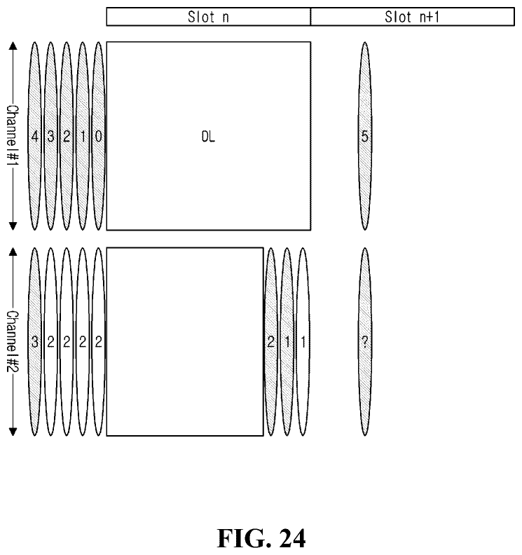

In the case of Type A, a base station performs a CAP individually for each of a plurality of channels based on a counter N defined according to each channel (e.g., counter N considered in the CAP) and performs a DL signal transmission based on the individual CAP. Type A may be divided into Type A1 and Type A2.
(1) Operation according to Type A1 in the current specifications: a counter N of each channel (e.g., RB set) is independently determined, and a DL signal transmission through each channel is performed based on a counter N of each channel. In case a backoff counter value decreases and pauses and then resumes, a base station restarts it from where the backoff counter pauses, or reinitializes the backoff counter value.
   According to various embodiments of the present disclosure, unlike the operation in the current specifications, a backoff counter value of a channel may be decreased while a transmission is being performed in another channel, which may necessitate a separate rule for managing the backoff counter value to be resumed in the channel. For example, the backoff counter value may be adjusted as shown in FIG. 24. FIG. 24 illustrates an example of adjustment of a backoff counter value for a CAP in a wireless communication system according to an embodiment of the present disclosure. As shown in FIG. 24, even when a transmission starts from a slot n in a channel #1, a base station capable of performing an FD operation may keep performing a CAP in a channel #2 during the slot n. Next, when the transmission in the slot n of the channel #1 is terminated and a multi-channel CAP procedure for the channel #1 and the channel #2 resumes, an N value for the channel #1 need to be reinitialized. Meanwhile, an N value for the channel #2 may be Opt1) 2, that is, a backoff counter value corresponding to the channel #2 at a DL transmission time in the channel #1 of the slot n, Opt2) 1, that is, a backoff counter value reflecting a result of a CAP that is continuously performed for the channel #2 also in the slot n, or Opt3) a reinitialized backoff counter value.
(2) Operation according to Type A2 in the current specifications: a value for a channel with a largest contention window size is determined as a counter N of each channel, and a DL signal transmission through a channel is performed based on the counter N of each channel. That is, a value of the counter N is applied as a common value for channels (e.g., maximum value), but the counter value may be decreased based on a busy/idle state of each channel. In case a back off counter value decreases, pauses and then resumes, the backoff counter may restart from where it pauses.
   According to various embodiments of the present disclosure, unlike the operation in the current specifications, a backoff counter value of a channel is possible to decrease while a transmission is being performed in another channel, which may necessitate readjustment of the backoff counter value corresponding the channel to be resumed. For example, in case a CAP according to Type A2 is being performed in the channels #1/#2/#3, if a DL signal transmission starts in the slot n of the channel #1 first, counter values in the channels #2/#3 may be adjusted to one common value (e.g., a maximum value, a minimum value or a mean value of a current counter value in the channel #2 and a current counter value in the channel #3, a counter value corresponding to a specific channel, or a newly selected value), and the counter value may be decreased depending on a busy/idle state of each channel.

In the case of Type B, a base station may perform a CAP based on a counter N only for a specific channel among a plurality of channels and perform a DL signal transmission prior to a signal transmission in the specific channel according to whether the remaining channels are idle. A base statin capable of performing an FD operation may keep performing a CAP also for remaining channels other than channels in which a DL transmission starts first. Herein, for the remaining channels other than the channels in which the DL transmission starts, the base station may perform a CAP (e.g., CAP Type 2) that allows a transmission when a channel is idle for a predetermined duration, instead of a random backoff-based CAP (e.g., CAP Type 1).

Alternatively, for the remaining channels or some of the channels other than the channels in which the DL transmission starts, the base station may apply a random backoff-based CAP (e.g., CAP Type 1). If a set of channel(s) other than channels, in which a DL transmission starts, is expressed by a set C, a Type A or Type B multi-channel CAP may be applied to channels belonging to the set C.

[Embodiment #4] Through CAP application of the above-described Embodiment #3, in the case of a base station capable of performing an FD operation, a channel occupancy start time may be different according to each channel. Herein, a start time of COT may be defined as follows.

(1) Embodiment #4-1: In case a set of channels, where a base station performs a multi-channel CAP operation, is referred to as ‘set_CH’ or ‘channel set’, if any one of channels in the set_CH starts being occupied, a time when the channel occupancy starts may be defined as a start time of COT. In other words, one COT may be defined at one time according to each set_CH. As shown in Table 6 above, a length of a maximum COT (MCOT) is defined according to a channel access priority class (CAPC) value, a start time of one COT is defined according to each_CH, and an MCOT length may be applied from the defined start time. For example, as shown in FIG. 19, even if a start time of channel occupancy is different according to each RB set or channel, a start time of a COT may be defined as a slot n, and channel occupancy of the base station may be allowed only for a duration within an MCOT from the slot n.

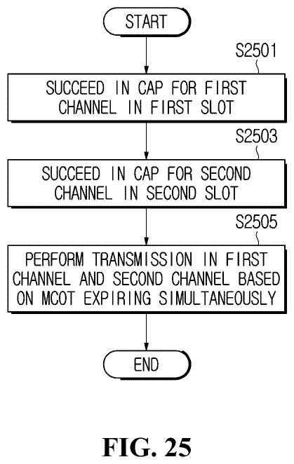

FIG. 25 illustrates an example of a procedure of transmitting a signal according to a channel occupancy time in a wireless communication system according to an embodiment of the present disclosure. FIG. 25 exemplifies a method for operating a base station.

Referring to FIG. 25, at step S2501, a base station succeeds in a CAP for a first channel in a first slot. Accordingly, the base station may configure an MCOT in the first slot, and transmission of a signal may subsequently be allowed for the MCOT. Herein, the MCOT may be determined based on a priority class of the base station for the first channel.

At step S2503, the base station succeeds in a CAP for a second channel in a second slot. Herein, the base station may succeed in the CAP for the second channel, while a transmission in the first slot is being performed. In other words, the base station succeeds in the CAP for the second channel before a COT of the first channel expires. That is, while the base station transmits a signal in the first channel, the base station may receive a signal in the second channel and identify that the second channel is in idle state based on the received signal. Accordingly, the base station configures an MCOT in the second slot, and a transmission of a signal may subsequently be allowed for the MCOT. Herein, according to an embodiment, the MCOT may be determined based on an end time of the COT in the first channel.

At step S2505, the base station performs transmissions in the first channel and the second channel based on an MCOT that expires at a same time. That is, the base station may configure a same expiration time of an MCOT for the first channel and the second channel and perform a DL transmission. That is, when CAP success is determined for a plurality of channels, even if a determination time of CAP success is different according to each channel, the base station may terminate the MCOT at a same time. Accordingly, when the base station continuously transmits a signal during an interval allowed in each channel, signal transmissions in the first channel and the second channel are all terminated at a same time. However, if transmissions of all signals are completed during an interval shorter than the MCOT, a transmission may be terminated in any one of the first channel or the second channel.

(2) Embodiment #4-2: A start time of a COT may be independently defined according to each channel or each group of channels belonging to a set_CH. If two channels with different channel occupancy start times because of different CAP success times have different CAPCs or carry an independent DL signal, each of the channels may be preferably treated as having started a COT independently of each other, and it may be desirable to apply a different MCOT limit. For example, as shown in FIG. 19, in case a start time of channel occupancy is different according to each RB set or channel, a start time of a COT on the RB set #1 may be defined as a slot n, and the channel occupancy of a base station may be allowed only for a duration within an MCOT from the slot n. On the other hand, a start time of a COT on the RB set #2 may be defined as a slot n+1, and the channel occupancy of the base station may be allowed only for a duration within the MCOT from the slot n+1.

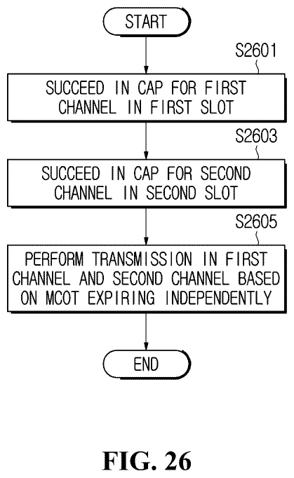

FIG. 26 illustrates an example of another procedure of transmitting a signal according to a channel occupancy time in a wireless communication system according to an embodiment of the present disclosure. FIG. 26 exemplifies a method for operating a base station.

Referring to FIG. 26, at step S2601, a base station succeeds in a CAP for a first channel in a first slot. Accordingly, the base station may configure a COT in the first slot and subsequently transmit a signal for the COT. Herein, the COT may be determined based on a priority class of the base station for the first channel.

At step S2603, the base station succeeds in a CAP for a second channel in a second slot. Herein, the base station may succeed in the CAP for the second channel, while a transmission in the first slot is being performed. In other words, the base station succeeds in the CAP for the second channel before a COT of the first channel expires. That is, while the base station transmits a signal in the first channel, the base station may receive a signal in the second channel and identify that the second channel is in idle state based on the received signal. Accordingly, the base station may configure a COT in the second slot and subsequently transmit a signal for the COT. Herein, according to an embodiment, the COT may be determined based on a priority class of the base station for the second channel.

At step S2605, the base station performs transmissions in the first channel and the second channel based on an MCOT that expires independently. That is, the base station may configure an end time of the MCOT in the first channel and an end time of the MCOT in the second channel independently based on a CAP success time in each channel and perform a DL transmission.

As shown in the embodiment described with reference to FIG. 26, in case a CAP operation for multiple channels is performed based on an FD operation, MCOT configuration according to CAP success of each channel may be independently performed. However, according to another embodiment, a rule may be defined such that among channels belonging to a set_CH, only for channels not belonging to a same carrier/BWP, a COT start time is allowed to be independently managed as in Embodiment #4-1, and for channels belonging to a same carrier/BWP, a COT start time may be identically configured as in Embodiment #4-2.

According to a relationship between priority classes of a base station corresponding to COTs of each channel, it may be determined which rule based on either Embodiment #4-1 or Embodiment #4-2 described above is to be applied. As an example, let a priority class of the base station corresponding to a first channel COT be p1 and a priority class of the base station corresponding to a second channel COT be p2. If p1=p2, Embodiment #4-1 may be applied, and otherwise, Embodiment #4-2 may be applied. Alternatively, if p1<p2 or if p1≤p2, Embodiment #4-1 may be applied, and otherwise, Embodiment #4-2 may be applied. Alternatively, if p1> p2 or if p1≥p2, Embodiment #4-1 may be applied, and otherwise, Embodiment #4-2 may be applied. Herein, a priority class of a base station corresponding to one COT may mean a priority class with a minimum value or a maximum value, if DL data included in the COT corresponds to a plurality of priority classes.

According to the various embodiments described above, while a base station and/or a terminal capable of operating in FD mode performs a transmission in a specific band, a CAP may be simultaneously performed through reception in a band adjacent to the band, and a transmission may be initiated after the CAP is successful, which enables a radio resource to be efficiently utilized.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

### INDUSTRIAL APPLICABILITY

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1-14. (canceled)

15. A method comprising:
transmitting system information including information related to frequency resources;
determining at least one threshold for energy detection (ED);
based on at least one of the system information or the at least one threshold, performing a first channel access procedure (CAP) for at least one channel;
based on the first CAP being successful in a first channel of the at least one channel, transmitting a signal in the first channel; and
performing a second CAP for a second channel of the at least one channel during transmission of the signal in the first channel,
wherein the configuration information indicates a size or a location of a frequency band, in which a full-duplex (FD) operation is allowed, by using a number of channels, which is a unit of performing the CAP, or a bitmap of which each bit corresponds to a channel that is a unit of performing the CAP.

16. The method of claim 15, wherein the configuration information indicates that a subband wise (SB)-FD operation is allowed in a frequency band including the first channel and the second channel.

17. The method of claim 15, wherein the configuration information indicates that a link direction of at least one of the first channel and the second channel is determined based on a result of the CAP.

18. The method of claim 15, wherein the performing of the second CAP for the second channel during the transmission of the signal in the first channel comprises performing the second CAP for the second channel based on a guard band including RBs equal to or greater than a threshold being configured between the first channel and the second channel.

19. The method of claim 15, further comprising receiving information related to a threshold of a guard band between the first channel and the second channel to determine whether the second CAP for the second channel is allowed during the transmission of the signal in the first channel.

20. The method of claim 15, wherein a second threshold of ED for the second CAP is configured to be greater than a first threshold of ED for the first CAP.

21. The method of claim 20, wherein a difference between the first threshold and the second threshold is determined is determined based on at least one of an adjacency degree between the first channel and the second channel and a transmission power in the first channel.

22. The method of claim 15, further comprising performing a third CAP for the first channel and the second channel after the signal transmission in the channel is completed,
wherein a backoff counter value for the second channel, which is applied in the third CAP, is determined based on a decreased value during the first CAP and a decreased value during the second CAP.

23. The method of claim 15, wherein the second CAP is performed according to a method of allowing transmission based on a channel being idle for a predetermined specific duration, irrespective of a backoff counter value.

24. The method of claim 15, wherein based on the second CAP for the second channel being successful, an end time of a maximum channel occupancy time (MCOT) of the first channel and an end time of an MCOT of the second channel are configured to be identical to each other.

25. The method of claim 15, wherein based on the second CAP for the second channel being successful, the end time of the MCOT of the first channel and the end time of the MCOT of the second channel are configured to be independent of each other.

26. A communication device comprising:
at least one processor; and
at least one computer memory coupled with the at least one processor and storing an instruction that instructs operations when executed by the at least one processor,
wherein the operations comprises:
transmitting system information including information related to frequency resources;
determining at least one threshold for energy detection (ED);
based on at least one of the system information or the at least one threshold, performing a first channel access procedure (CAP) for the at least one channel;
based on the first CAP being successful in a first channel of the at least one channel, transmitting a signal in the first channel; and
performing a second CAP for a second channel of the at least one channel during transmission of the signal in the first channel, and
wherein the configuration information indicates a size or a location of a frequency band, in which a full-duplex (FD) operation is allowed, by using a number of channels, which is a unit of performing the CAP, or a bitmap of which each bit corresponds to a channel that is a unit of performing the CAP.

27. A base station comprising:
a transceiver; and
a processor coupled with the transceiver,
wherein the processor is configured to:
transmit system information including information related to frequency resources,
determine at least one threshold for energy detection (ED),
based on at least one of the system information or the at least one threshold, perform a first channel access procedure (CAP) for the at least one channel,
based on the first CAP being successful in a first channel of the at least one channel, transmit a signal in the first channel, and
perform a second CAP for a second channel of the at least one channel during transmission of the signal in the first channel, and
wherein the configuration information indicates a size or a location of a frequency band, in which a full-duplex (FD) operation is allowed, by using a number of channels, which is a unit of performing the CAP, or a bitmap of which each bit corresponds to a channel that is a unit of performing the CAP.

28. The base station of claim 27, wherein the configuration information indicates that a subband wise (SB)-FD operation is allowed in a frequency band including the first channel and the second channel.

29. The base station of claim 27, wherein the configuration information indicates that a link direction of at least one of the first channel and the second channel is determined based on a result of the CAP.

30. The base station of claim 27, wherein the performing of the second CAP for the second channel during the transmission of the signal in the first channel comprises performing the second CAP for the second channel based on a guard band including RBs equal to or greater than a threshold being configured between the first channel and the second channel.

31. The base station of claim 27, wherein the processor is further configured to:
receive information related to a threshold of a guard band between the first channel and the second channel to determine whether the second CAP for the second channel is allowed during the transmission of the signal in the first channel.

32. The base station of claim 27, wherein a second threshold of ED for the second CAP is configured to be greater than a first threshold of ED for the first CAP.

33. The base station of claim 27, wherein the processor is further configured to:
perform a third CAP for the first channel and the second channel after the signal transmission in the channel is completed,
wherein a backoff counter value for the second channel, which is applied in the third CAP, is determined based on a decreased value during the first CAP and a decreased value during the second CAP.

34. The base station of claim 27, wherein the second CAP is performed according to a method of allowing transmission based on a channel being idle for a predetermined specific duration, irrespective of a backoff counter value.
